(19) United States
(12) Patent Application Publication
(10) Pub. No.: US 2025/0059798 A1
(43) Pub. Date: Feb. 20, 2025

(54) MANUAL ELECTRONIC DEADBOLT WITH EGRESS ASSISTANCE

(71) Applicant: ASSA ABLOY Americas Residential Inc., New Haven, CT (US)

(72) Inventor: Derek Imanuel, Irvine, CA (US)

(21) Appl. No.: 18/805,015

(22) Filed: Aug. 14, 2024

Related U.S. Application Data
(60) Provisional application No. 63/519,298, filed on Aug. 14, 2023.

(51) Int. Cl. E05B 47/00; E05B 43/00

(52) U.S. Cl. CPC E05B 47/0012; E05B 43/005; E05B 2047/0026; E05B 2047/0069

(57) ABSTRACT

An electronically-controlled manually-actuated deadbolt lock is provided. The electronically-controlled manually-actuated deadbolt lock includes an exterior turn piece selectively couplable to a deadbolt latch assembly including a latch bolt. When a control circuit determines that rotation of an internal turn piece drives movement of the latch bolt from a locked position to an unlocked position, the control circuit engages a motor to transition the exterior turn piece to a coupled state for, at most, a predetermined period of time. While in the coupled state during the predetermined period of time, rotation of the exterior turn piece drives movement of the latch bolt between the locked and unlocked positions.

### CROSS-REFERENCE TO RELATED APPLICATIONS

This application claims priority to U.S. Provisional Patent Application No. 63/519,298 filed Aug. 14, 2023, the disclosure of which is incorporated herein by reference in its entirety.

### TECHNICAL FIELD

This invention relates to the field of electronic locks. More particularly, this invention relates to systems and methods of providing an electronically-controlled, manually-actuated deadbolt lock with egress assistance.

### BACKGROUND

Electronically-controlled locks have gained increasing acceptance and widespread use in residential and commercial markets due to various benefits they provide. One such benefit to a user is a convenience of not needing to use a key to open a door. For example, an electronically-controlled lock may be controllable by scanning a near-field communication (NFC) fob which when authenticated may allow the user to retract or extend a deadbolt. In other examples, a user may be able to control an electronically-controlled lock via an application on a computing device, such as a smartphone, or by a keypad associated with the lock. Some electronically-controlled locks may include an electronic motor to automatically retract or extend the deadbolt. Other electronically-controlled locks may be manually actuated, in that electronic components may be used to selectively couple an exterior manual turn piece to the latch mechanism of the deadbolt. Such manually-actuated, electronically-controlled locks require manual use of a turn piece to move the deadbolt between locked and unlocked positions.

Although electronically-controlled, manually-actuated locks provide the convenience of not needing to use a key to open a door, they may lack additional conveniences of electronically-controlled locks that automatically actuate the deadbolt. For example, when a user is leaving a location with an electronically-controlled, manually-actuated lock, the user may still need to provide authentication to the lock—e.g., through an NFC fob, keypad, or application—to electronically couple the exterior manual turn piece to the latch mechanism of the deadbolt before engaging the exterior turn piece (to lock the door as the user is leaving the premises).

### SUMMARY

Aspects of the present disclosure relate generally to an electronically-controlled, manually-actuated deadbolt lock with egress assistance. When a latch bolt is transitioned into an unlocked position with an interior turn piece, an exterior turn piece is temporarily coupled to the latch bolt, allowing the exterior turn piece to transition the latch bolt into a locked position without needing to first provide authentication to the electronically-controlled lock.

In a first aspect, an electronically-controlled, manually-actuated lock is provided. The lock comprises a deadbolt latch assembly including a latch bolt movable between a locked position and an unlocked position, an interior turn piece coupled to the deadbolt latch assembly, an exterior turn piece selectively coupled to the deadbolt latch assembly, a control circuit, and a motor coupled with the control circuit. Rotation of the interior turn piece drives movement of the latch bolt between the locked and unlocked positions. When the exterior turn piece is in a coupled state, rotation of the exterior turn piece drives movement of the latch bolt between the locked and unlocked positions. When the control circuit determines that rotation of the interior turn piece drives movement of the latch bolt from the locked position to the unlocked position, the control circuit engages the motor to transition the exterior turn piece into the coupled state for, at most, a predetermined amount of time.

In a second aspect, a method for managing egress at a door is provided. A determination is made that a deadbolt latch has been moved from a locked position to an unlocked position by an interior turn piece. A motor is engaged to transition an exterior turn piece into a coupled state for, at most, a predetermined amount of time. When the exterior turn piece is in the coupled state, rotation of the exterior turn piece drives movement of the latch bolt between the locked and unlocked positions. In a decoupled state, the exterior turn piece is mechanically disengaged from the latch bolt.

In a third aspect, a system for managing egress at a door is provided. The system includes an electronic lock. The electronic lock includes a deadbolt latch assembly including a latch bolt movable between a locked position and an unlocked position, an interior turn piece coupled to the deadbolt latch assembly, an exterior turn piece selectively coupled to the deadbolt latch assembly, a control circuit, and a motor coupled with the control circuit. Rotation of the interior turn piece drives movement of the latch bolt between the locked and unlocked positions. In a coupled state, rotation of the exterior turn piece drives movement of the latch bolt between the locked and unlocked positions. In a decoupled state, the exterior turn piece is mechanically disengaged from the latch bolt. When the control circuit determines that rotation of the interior turn piece drives movement of the latch bolt from the locked position to the unlocked position, the control circuit engages the motor to transition the electronic lock into the coupled state for, at most, a predetermined amount of time.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates a schematic representation of an example electronic lock according to an embodiment.

FIG. 2A illustrates a perspective view of the example electronic lock installed in a door.

FIG. 2B illustrates a perspective view of a portion of an exterior assembly of the example electronic lock.

FIG. 2C illustrates a partially-exploded perspective view of a portion of an interior assembly, a deadbolt assembly, and a portion of a bezel assembly of the example electronic lock.

FIG. 3 illustrates a side view of the example electronic lock installed in a door.

FIG. 4 illustrates a front perspective view of the interior assembly and a rear perspective view of a portion of the exterior assembly of the example electronic lock.

FIG. 5 illustrates a front perspective view of the exterior assembly and a rear perspective view of a portion of the interior assembly of the example electronic lock.

FIG. 6A illustrates an exploded perspective view of the bezel assembly of the example electronic lock.

FIG. 6B illustrates a section view of the bezel assembly of the example electronic lock.

FIG. 7A illustrates an exploded view of internal components of the exterior assembly as viewed from a front perspective of the example electronic lock.

FIG. 7B illustrates an exploded view of the internal components of the exterior assembly as viewed from an rear perspective of the example electronic lock.

FIG. 8A illustrates a front view of the bezel assembly and a mechanical lock assembly of the example electronic lock.

FIG. 8B illustrates a rear view of the bezel assembly of FIG. 8A, wherein the bezel assembly is operatively connected to an adaptor.

FIG. 9 illustrates a front perspective view of the bezel assembly and adaptor of FIGS. 8A and 8B.

FIG. 10 illustrates a rear view of the internal mechanisms of the example electronic lock in an unengaged state.

FIG. 11 illustrates a rear view of the internal mechanisms of the example electronic lock in an engaged state.

FIG. 12 illustrates a rear view of the internal mechanisms of the example electronic lock in an engaged state and the bezel assembly rotated.

FIG. 13 illustrates a perspective cross-sectional view of the bezel assembly, the mechanical lock assembly, a motor, an engagement mechanism, and a coupling mechanism of the example electronic lock, wherein the electronic lock is in an engaged state.

FIG. 14 illustrates a side cross-sectional view of the bezel assembly, the mechanical lock assembly, the motor, the engagement mechanism, and the coupling mechanism of the example electronic lock, wherein the electronic lock is in an unengaged state.

FIG. 15 illustrates a side cross-sectional view of the bezel assembly, the mechanical lock assembly, the motor, the engagement mechanism, and the coupling mechanism of the example electronic lock, wherein the electronic lock is in an engaged state.

FIG. 16A illustrates a front view of the interior assembly of the example electronic lock, wherein the lock is in an unlocked state.

FIG. 16B illustrates a rear view of the interior assembly of the example electronic lock without a cover, wherein the lock is in an unlocked state.

FIG. 17A illustrates a front view of the interior assembly of the example electronic lock, wherein the lock is in a locked state.

FIG. 17B illustrates a rear view of the interior assembly of the example electronic lock without a cover, wherein the lock is in a locked state.

FIG. 18 illustrates a flowchart of a method of how the example electronic lock can be used to lock and unlock a door.

FIG. 19 illustrates a flowchart of a method of managing egress at a door.

FIG. 20 illustrates a schematic representation of the electronic lock seen in the environment of FIG. 2A.

FIG. 21 illustrates an environment in which a user may control an electronic lock with a mobile device.

FIG. 22 illustrates a schematic representation of the mobile device of FIG. 21.

FIG. 23 illustrates a user interface of an electronic lock application for customizing settings of an electronic lock.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As briefly described above, the present disclosure relates generally to providing a manually-actuated, electronically-controlled deadbolt lock with egress assistance. In example aspects, the electronic lock includes an exterior turn piece that is configured to selectively drive a deadbolt latch between locked and unlocked positions. When a user is electronically authenticated, the electronic lock will couple the exterior turn piece with the deadbolt latch such that rotation of the exterior turn piece drives movement of the deadbolt latch between the locked and unlocked positions. The electronic lock may further include an internal turn piece that is engaged with the deadbolt latch and capable of driving movement of the deadbolt latch between the locked and unlocked positions. A control circuit in the electronic lock may monitor a position of the deadbolt latch as well as a position of a coupling mechanism and/or the internal turn piece.

By monitoring the positions of the deadbolt latch as well as the coupling mechanism and/or the internal turn piece, the electronically-controlled lock may assist a user in egress. For example, when the electronically-controlled lock detects that the internal turn piece has been rotated to move the deadbolt latch from the locked position to the unlocked position, the electronically-controlled lock may temporarily couple the exterior turn piece with the deadbolt latch, allowing the user to then rotate the exterior turn piece to move the deadbolt latch from the unlocked position to the locked position without the user needing to provide authentication.

In example implementations, the exterior turn piece may be coupled with the deadbolt latch for a predetermined amount of time (e.g., between 5 and 20 seconds). In alternative embodiments, the predetermined amount of time may be cut short by the electronically-controlled lock detecting that the latch is moved to the locked position, thereby indicating that the user has exited the premises and manually actuated the lock from the exterior turn piece. As such, the exterior turn piece may be disengaged from the latch in less than the predetermined amount of time. Other configurations are possible as well.

The term “lock” or “lockset” is broadly intended to include any type of lock, including but not limited to, deadbolts, knob locks, lever handle locks, mortise locks, and slide locks, whether mechanical, electrical, or electro-mechanical locks. The locking points may have various mounting configurations and/or locations, including but not limited to: mortised within the doorframe, mounted externally to the doorframe or support structure, and/or affixed directly to the door. Although this disclosure describes these features as implemented on an electronic deadbolt lock for purposes of example, these features are applicable to any type of lockset, including but not limited to, deadbolts, knobset locks, handleset locks, etc.

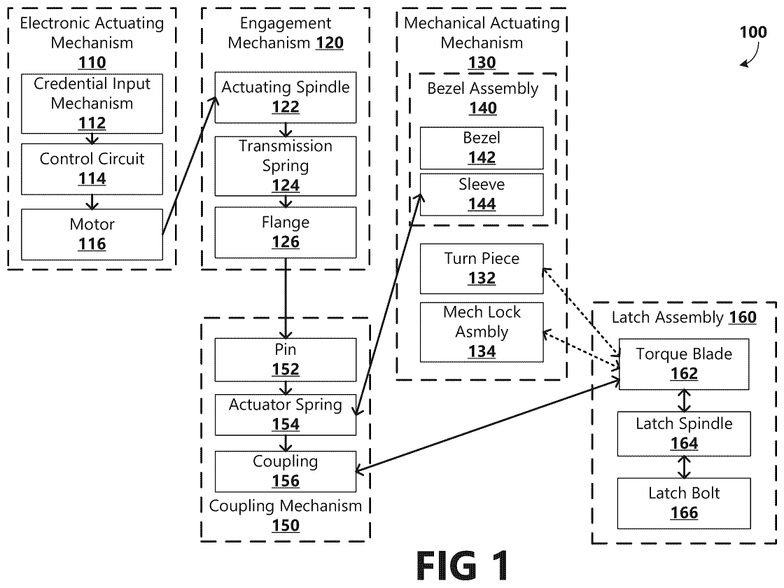

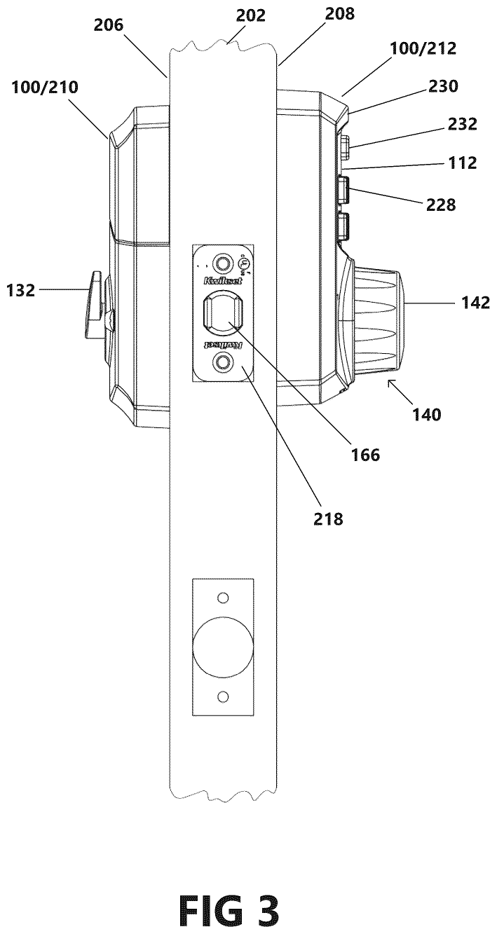

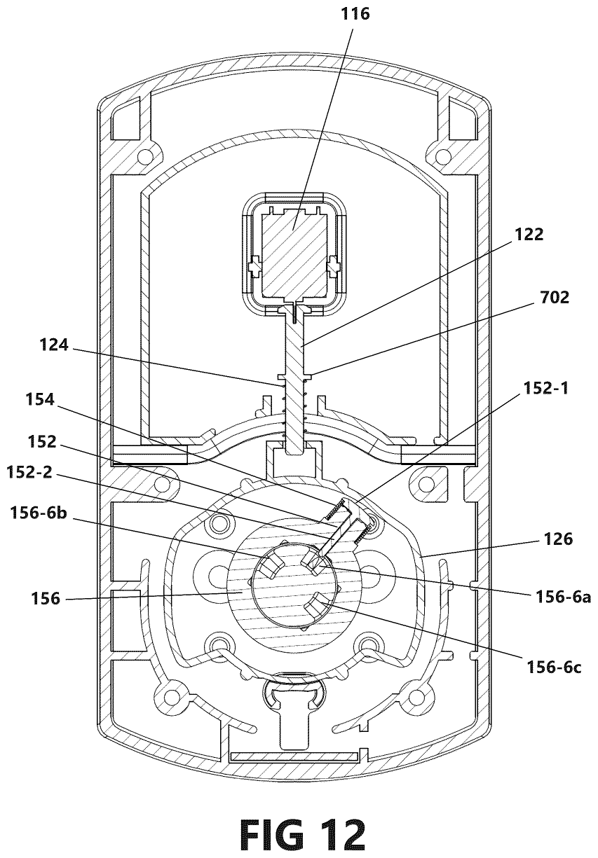

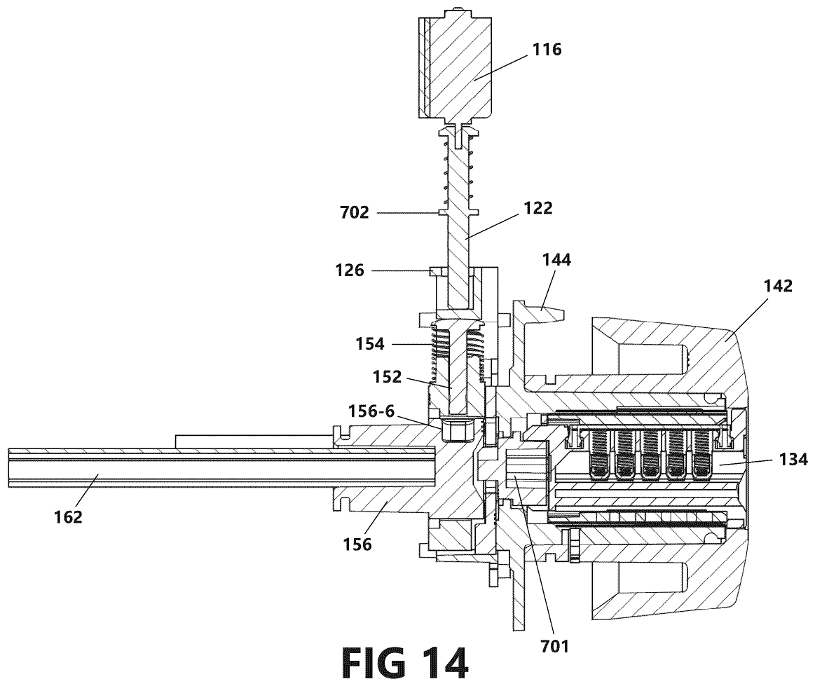

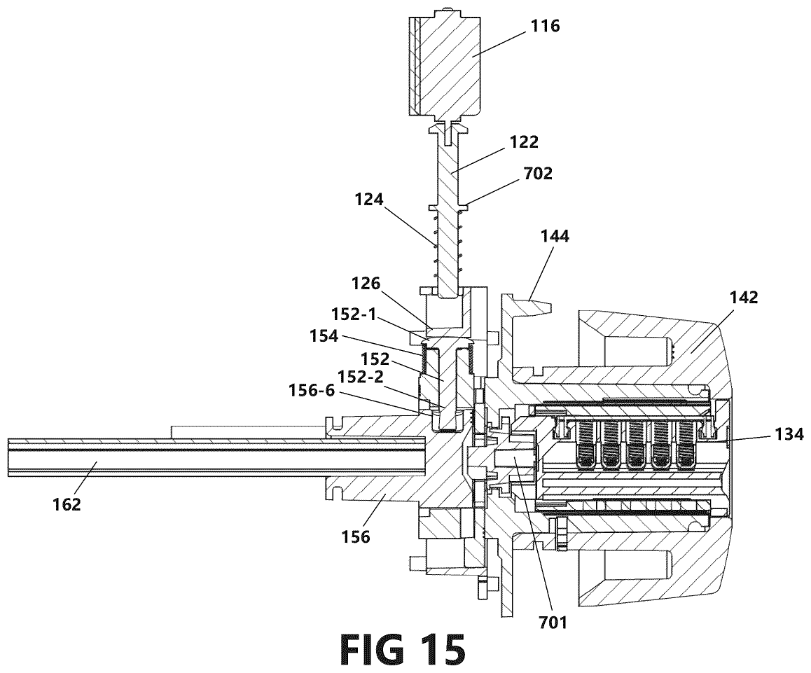

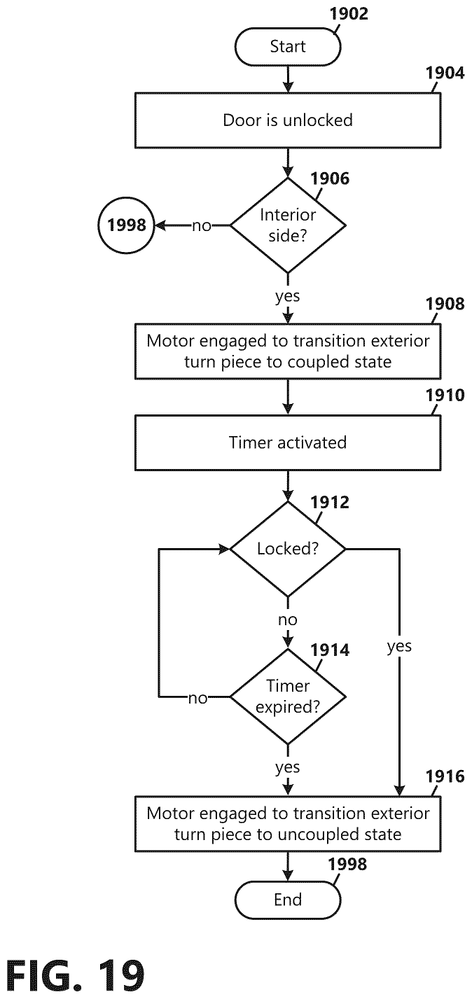

Referring to the present disclosure generally, FIGS. 1-18 generally describe construction and operation of an example electronic lock in which aspects of the present disclosure may be implemented. FIGS. 19-21 illustrate example methods of operation and additional features of such an electronic lock that improve user convenience with egress, in accordance with aspects of the present disclosure.

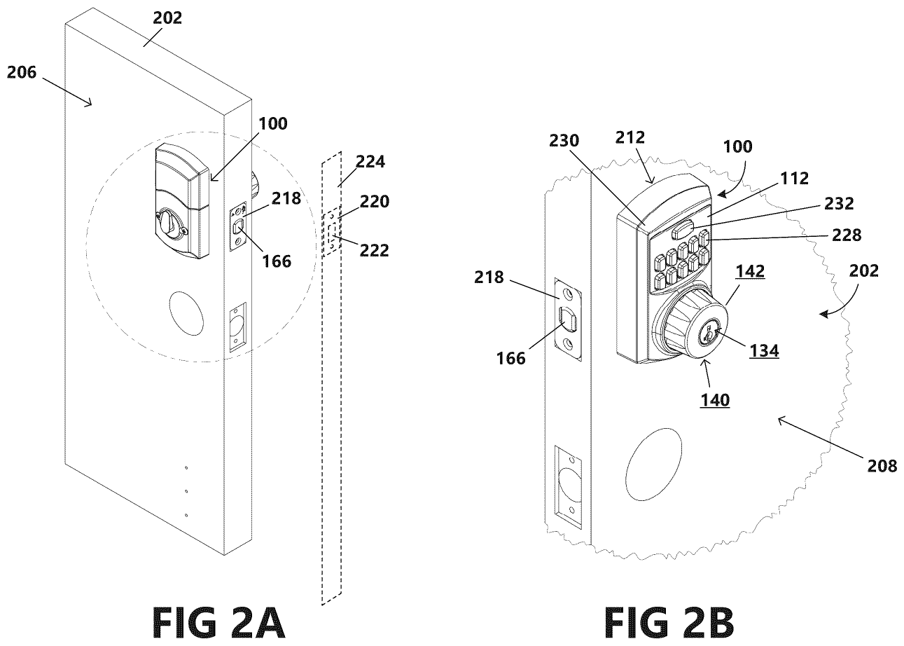

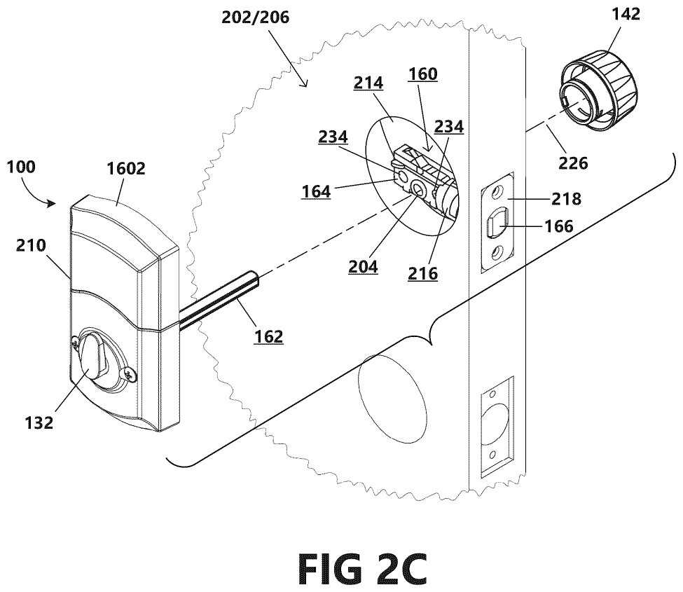

FIG. 1 is a block diagram showing a schematic representation of an example electronic lock 100 according to an embodiment of the present disclosure. The schematic representation provided in FIG. 1 is intended to simplify and facilitate discussion herein of functional relationships between components of the electronic lock 100, while reference may be made to FIGS. 2-17, which provide various perspective representations of the electronic lock 100 that are intended to facilitate communication of the assembly and mating relationships of these components. As shown in FIGS. 2A-2C, the electronic lock 100 is configured to be mounted on a door 202. The door 202 can be an exterior entry door or an interior door and has an interior side 206 and an exterior side 208. With an exterior entry door 202, for example, the exterior side 208 may be outside a building, while the interior side 206 may be inside a building. With an interior door 202, the exterior side 208 may be inside a building, but may refer to outside a room secured by the electronic lock 100, and the interior side 206 may refer to inside the secured room. The electronic lock 100 generally includes an interior assembly 210, an exterior assembly 212, and a deadbolt latch assembly 160. Typically, the interior assembly 210 is mounted to the interior side 206 of the door 202 and the exterior assembly 212 is mounted to the exterior side 208 of the door 202.

The interior assembly 210 generally houses internal components of the internal assembly 210 as explained below, and includes a mechanical actuating mechanism 130 embodied as a turn piece 132 that may be rotated by a user to manually operate the deadbolt latch assembly 160. The exterior assembly 212 generally includes an electronic actuating mechanism 110, an engagement mechanism 120, a coupling mechanism 150, a mechanical actuating mechanism 130 embodied as a bezel assembly 140, and a mechanical actuating mechanism 130 embodied as a lock cylinder 134. While embodied as a bezel assembly 140 in the illustrated embodiments, the mechanical actuating mechanism 130 may be any other type of turn piece in alternative embodiments. In some examples, the exterior assembly 212 may lack a lock cylinder, and only may actuate the latch assembly 160 via the bezel assembly 140 (or equivalent handle, knob, or other mechanical actuating device as described herein).

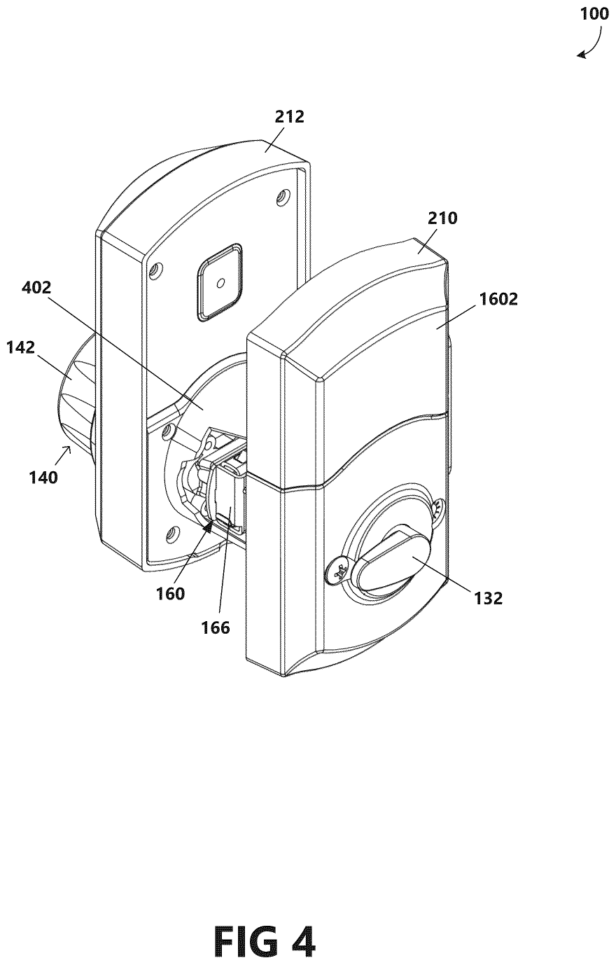

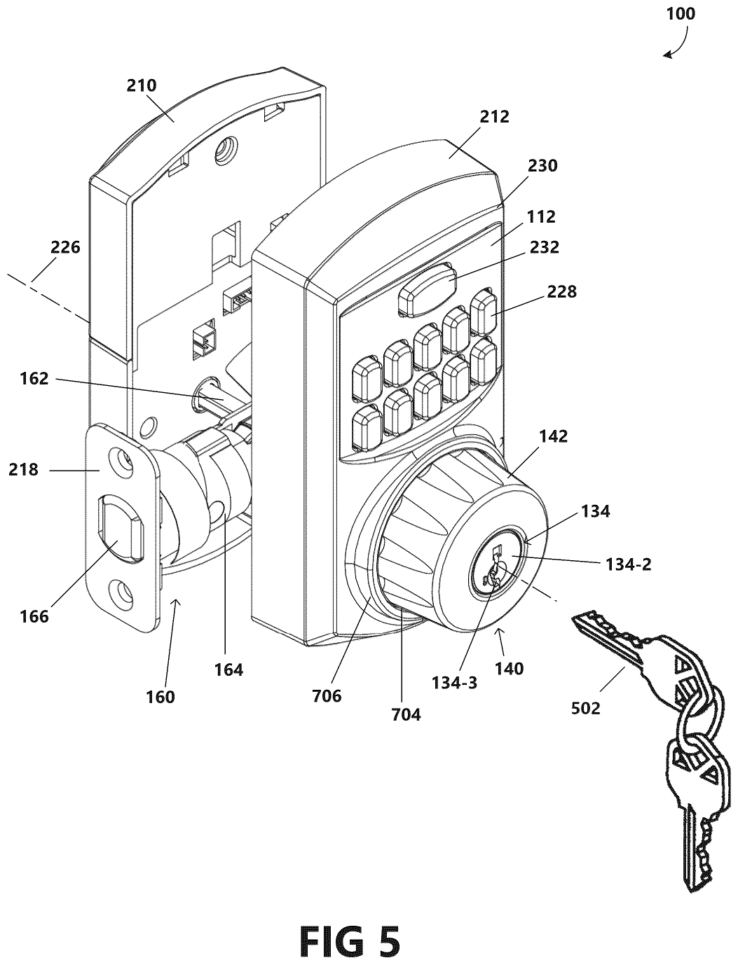

The latch assembly 160, is best shown in FIGS. 2C and 5. The latch assembly 160 generally comprises a torque blade 162, a latch bolt 166 that extends into a locked position and retracts into an unlocked position, and a latch spindle 164 that connects the torque blade 162 to the latch bolt 166. As shown in the partially exploded perspective view in FIG. 2C, the latch assembly 160 is at least partially mounted in a bore 214 formed in the door 202 and is designed to be actuated manually by a mechanical actuating mechanism 130 to extend and retract the latch bolt 166. The latch assembly 160 is at least partially housed in an adaptor 402 (shown in FIGS. 4, 7A, 7B, and 9) that defines a recessed area for internal components. The latch assembly 160 may include a housing 216 that carries the extendable/retractable latch bolt 166. The latch bolt 166 moves linearly in and out of the housing 216.

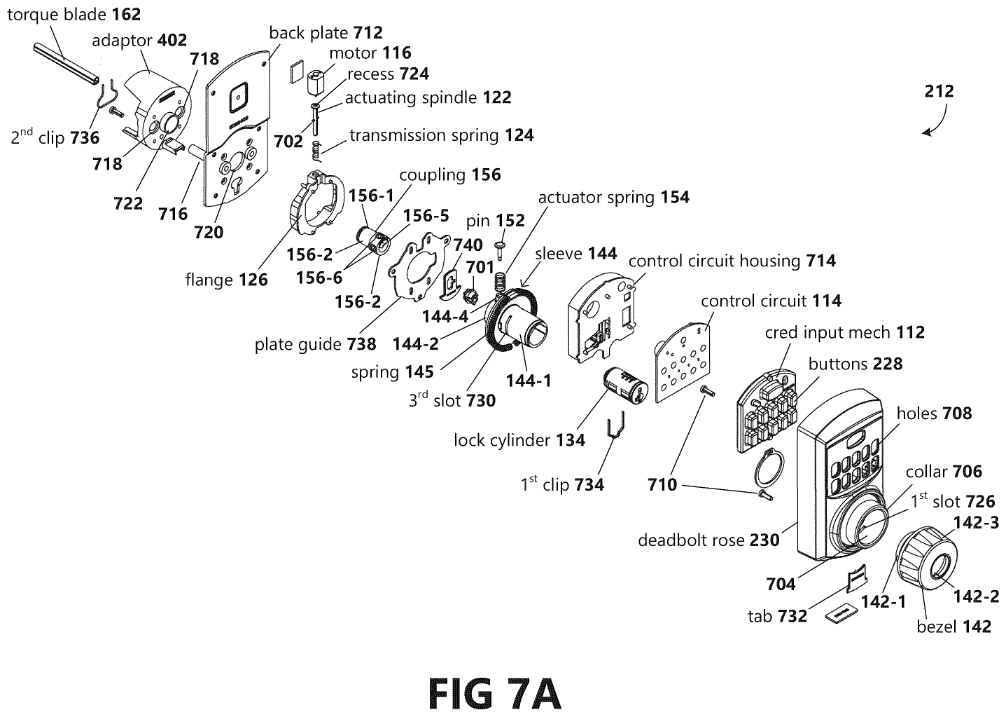

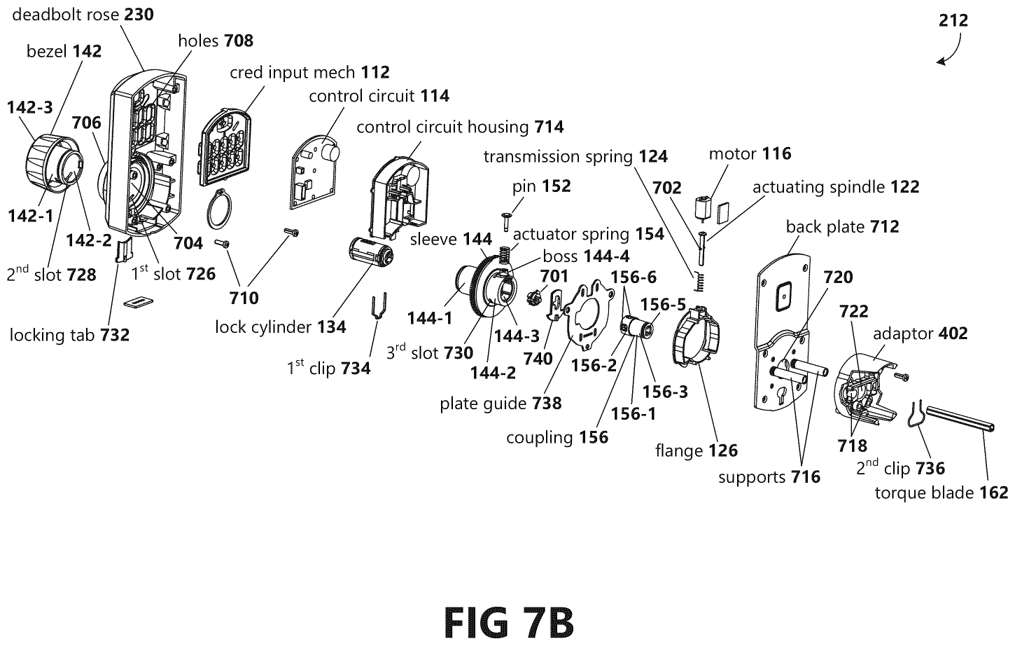

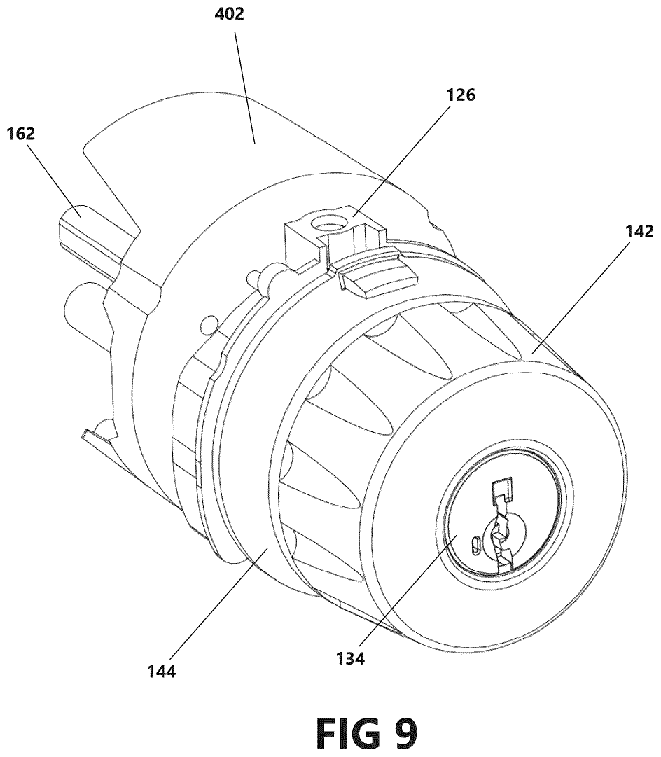

As is best shown in FIGS. 7A, 7B, and 9, the torque blade 162 is non-circular (e.g., having a square or D-shaped cross-section), and has a first end that is operatively connected to the lock cylinder 134 and extends longitudinally therefrom. The torque blade 162 is configured to drive the latch spindle 164 by a rotation of the torque blade 162. Thus, the torque blade 162 is configured to be drivably received in an opening (i.e., a spindle passage 204) in the latch spindle 164 that corresponds to a cross section shape (e.g., square, D-shaped) of torque blade 162. When the torque blade 162 is rotated in a first direction, a rotational force is conveyed to the latch spindle 164, which causes the latch bolt 166 to extend into a locked position. When the torque blade 162 is rotated in the opposing direction, a rotational force is conveyed to the latch spindle 164, which causes the latch bolt 166 to retract into an unlocked position. When the latch bolt 166 is in a retracted position, one end of the latch bolt 166 is generally flush with a latch plate 218. In some examples, the latch plate 218 may be attached to the door 202 with fasteners. When the latch bolt 166 is in an extended position, the latch bolt 166 protrudes through an opening of the latch plate 218 and through an opening 222 of a strike plate 220 positioned in the adjacent doorjamb 224. As is typical, the strike plate 220 may be made of metal, recessed in the doorjamb 224, and may be attached to the doorjamb 224 using fasteners. The strike plate 220 is configured to receive the latch bolt 166 when the door 202 is closed and when the latch bolt 166 is extended. A retracted position is broadly used to denote an “unlocked” position and an extended position is broadly used to denote a “locked” position.

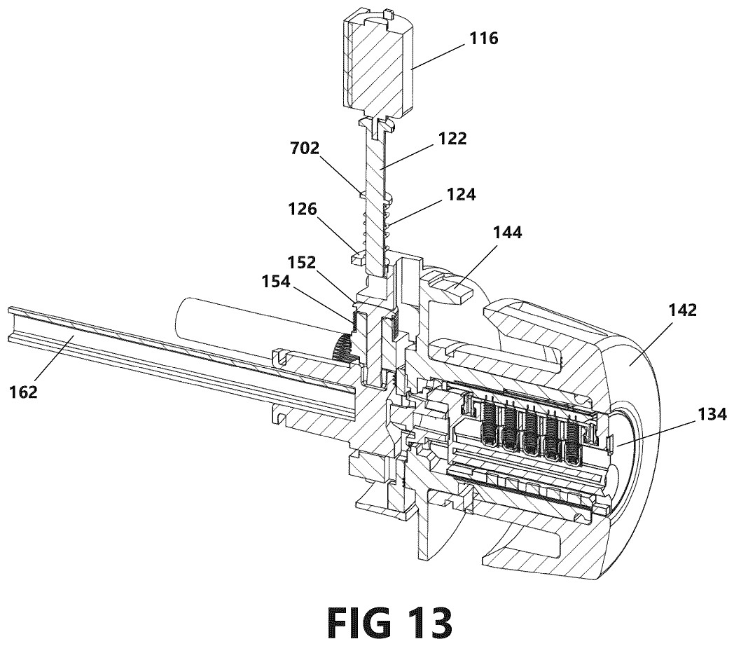

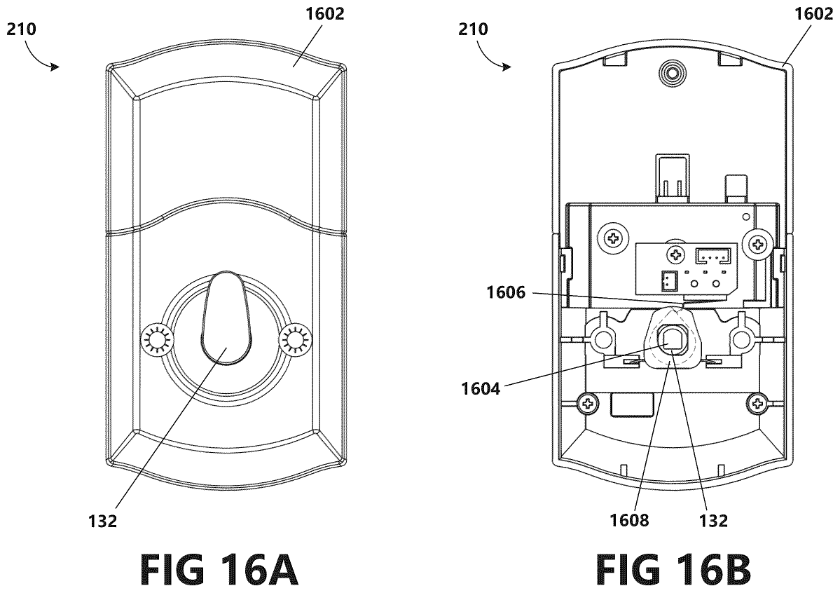

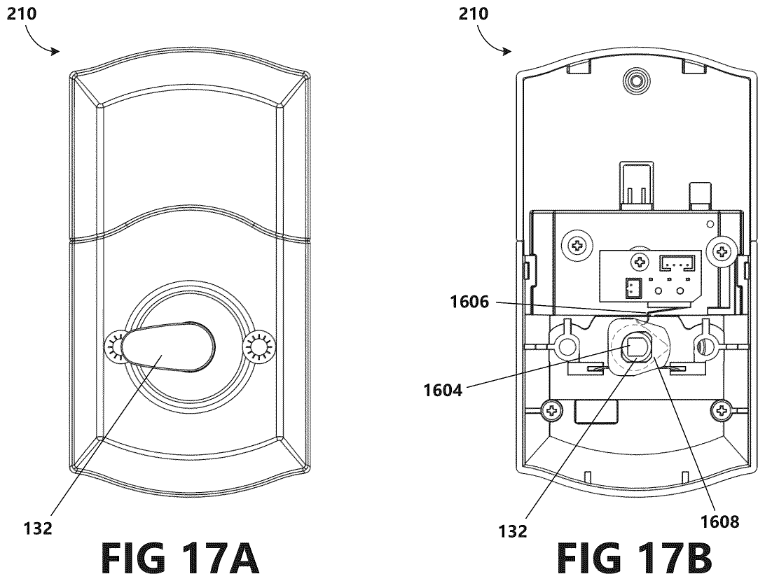

The mechanical actuating mechanism 130 includes, in the embodiment shown, a bezel assembly 140 and a lock cylinder 134 that are configured to be located on the exterior side 208 of the door 202, and a mechanical turn piece 132 that is configured to be located on the interior side 206 of the door 202. As best shown in FIGS. 13-15, the lock cylinder 134 is operatively attached to one end of the torque blade 162; and as best shown in FIGS. 16B and 17B, a rear side of the interior turn piece 132 has a recess 1604 that is dimensioned to receive the other end of the torque blade 162. The interior turn piece 132 is continuously drivably connected to the latch assembly 160 via the torque blade 162. As such, in normal operation, a rotation of the interior turn piece 132 effects a rotation of the torque blade 162 to operate the latch bolt 166.

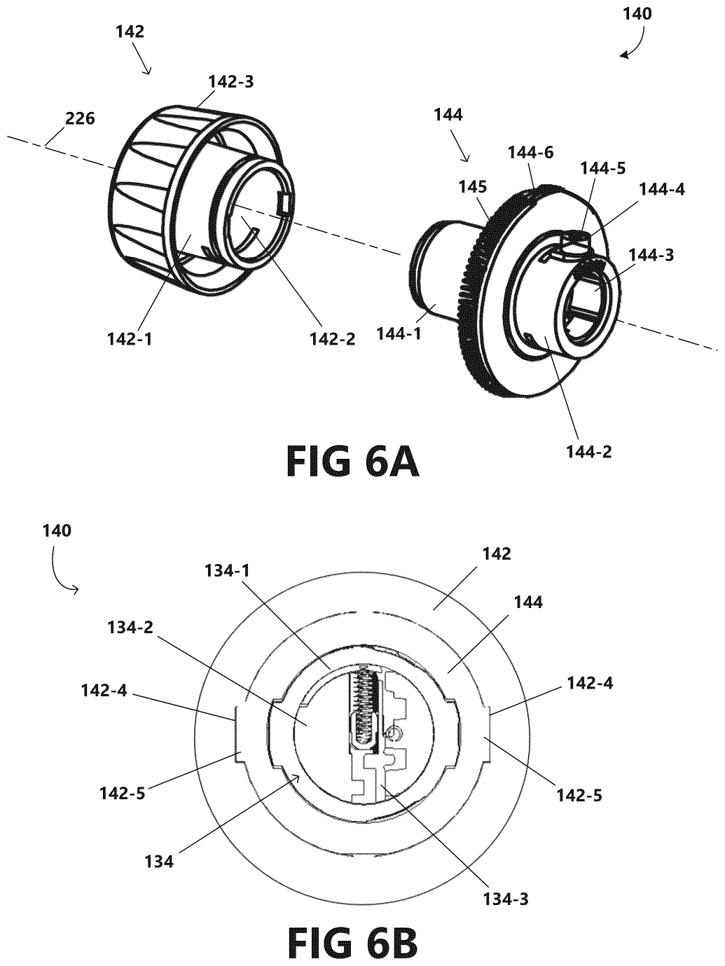

The lock cylinder 134 is shown in FIGS. 2B, 5, 6B, 7A, 7B, 8A, 9, and 13-15. As best shown in FIG. 6B, the lock cylinder 134 includes a cylinder housing 134-1 in which a cylinder plug 134-2 is housed. As best shown in FIG. 5, a first end of the cylinder plug 134-2 has a keyway 134-3 to allow a mechanical key 502 to enter the plug 134-2. When the key is rotated, the cylinder plug 134-2 rotates to turn a driver 701. The driver 701 activates a cam 740 (shown in FIGS. 7A and 7B), which is inserted into the sleeve. When a key is rotated 90 degrees, the cam 740 pushes down on a flange 126. The flange 126 pushes a pin 152 down and collapses an actuator spring 154. At the end of key rotation, the pin 152 is fully engaged in a slot of a coupling 156, thereby allowing operation of the latch bolt 166. As such, in normal operation, a rotation of a valid mechanical key 502 engages the pin 152 with the coupling 156, allowing a user to rotate a bezel 142 and the cylinder plug 134-2, which effects a rotation of the torque blade 162 to operate the latch bolt 166.

In example embodiments, the cylinder plug 134-2 may be a rekeyable cylinder plug, such as is described in U.S. Pat. No. 11,572,708, entitled “Rekeyable Lock with Small Increments,” or U.S. Pat. No. 10,612,271, entitled “Rekeyable Lock Cylinder With Enhanced Torque Resistance,” the disclosures of which are hereby incorporated by reference in their entireties.

In some examples, the lock cylinder 134 may be used in combination with another authentication factor (e.g., a passcode, a biometric input, a wireless signal), or alternatively, may be used instead of entering another authentication factor. As shown in FIGS. 2B, 5, 8A, 9, and 13, a first end of the first end of the cylinder plug 134-2 including the keyway 134-3 is exposed to the exterior through an opening in the bezel assembly 140.

The bezel assembly 140, which is best shown in FIGS. 6A and 6B, is selectively drivably coupled to the latch assembly 160. The bezel assembly 140 includes a manually-operable bezel 142, which is shown in FIGS. 2B, 2C, 3, 5, 6A, 6B, 7A, 7B, 8A, 9, and 13-15, and a sleeve 144, which is shown in FIGS. 6A, 6B, 7A, 7B, and 9-15. With reference to FIG. 6A, the bezel 142 has a grip portion 142-3 and a body portion 142-1 comprising a longitudinal opening 142-2 within which the body portion 144-1 of the sleeve 144 is slidably received. The grip portion 142-3 is designed to be gripped by a user and to be rotated along a rotational axis 226.

The bezel 142 and the sleeve 144 are rotatably coupled and are configured to be rotatable around the rotational axis 226. The body portion 144-1 of the sleeve 144 is configured to house the lock cylinder 134. As is best seen in FIG. 6B, the inside perimeter of the body portion 142-1 of the bezel 142 includes one or more recesses 142-4, and the outside perimeter of the body portion 144-1 of the sleeve 144 includes one or more tabs 142-5 that extend radially outward. The one or more tabs 142-5 are designed to engage the one or more recesses 142-4 such that the bezel 142 and the sleeve 144 are rotatably coupled. Accordingly, when a rotational force is applied to the bezel 142, the sleeve 144 is engaged with and rotates the bezel 142.

In the example shown, a circumferentially-located spring 145 is positioned around a circumference of the sleeve 144, and is compressible via a tab 144-6 of the sleeve. Accordingly, when the bezel 142 is rotated alongside the sleeve 144, the spring 145 is compressed. When the bezel is released, the spring returns the bezel 142 and sleeve 144 to a “home” or starting/default position.

A coupling portion 144-2 of the sleeve 144 comprises a longitudinal opening 144-3, within which a portion of the coupling mechanism 150 is received, and a boss 144-4 that extends radially outward in a vertical direction from a side wall of the coupling portion 144-2 of the sleeve 144. The boss 144-4 comprises a longitudinal bore 144-5 that receives at least a portion of a coupling member (e.g., a pin 152 described below) in a radial direction relative to the rotational axis 226.

The torque blade 162 is configured to be selectively manually driven by a rotation of the bezel assembly 140. For example, when the lock 100 is in an engaged state, the bezel assembly 140 may be in a coupled state in which the bezel assembly 140 is drivably coupled to the torque blade 162 via the engagement mechanism 120 and the coupling mechanism 150, and a rotation of the manually-operable bezel 142 effects a rotation of the torque blade 162 to operate the latch bolt 166. A second end of the torque blade 162 is configured to extend through and be drivably received in an opening 156-5 defined in a coupling 156 (included in the coupling mechanism 150 described below) that corresponds to the shape of the cross-section shape of the torque blade 162. As will be described below, the coupling 156 can be selectively engaged with the bezel assembly 140, such that rotation of the bezel assembly 140 causes the coupling 156 to rotate, and thus drives rotation of the torque blade 162.

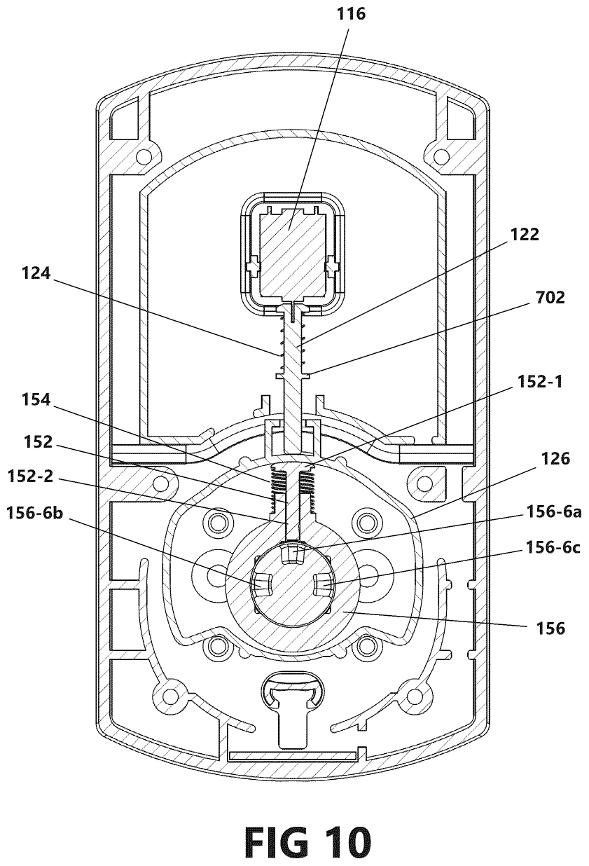

Alternatively, when the lock 100 is in an unengaged state, the bezel assembly 140 may be in a decoupled state in which the bezel assembly 140 is drivably decoupled from the torque blade 162, and therefore the manually-operable bezel 142 is incapable of rotating the torque blade 162 to operate the latch bolt 166. In example embodiments, the manually-operable bezel 142 is free-spinning when rotated and decoupled from the torque blade 162; in alternative embodiments, the manually-operable bezel 142 may be freely rotatable within a particular range of rotation angles, or biased toward a predetermined position in which the coupling 156 is engageable by the bezel assembly 140 (e.g., a default position, such as the position seen in FIG. 10.

Accordingly, the torque blade 162 can be manually rotated when the turn piece 132 located on the interior side 206 of the door 202 is manually turned, when a valid mechanical key 502 is inserted into and turned within the lock cylinder 134, or when the lock 100 is placed in an engaged state and the exterior bezel assembly 140 is manually rotated. According to an aspect, the engagement state (i.e., engaged state versus disengaged state) of the lock 100 is electronically controlled via the electronic actuating mechanism 110.

The electronic actuating mechanism 110 includes a credential input mechanism 112, a control circuit 114, and a motor 116. An example credential input mechanism 112 is shown in FIGS. 2B, 3, 5, 7A, and 7B. The credential input mechanism 112 is located on the exterior side 208 of the door 202 and is configured to receive and communicate an electronic credential (e.g., a passcode or security token entered via a keypad (as shown), a biometric input received via a biometric sensor (not shown), a wireless signal received via a wireless interface (not shown), or other electronic credential) to the control circuit 114 for authentication of a user.

In some examples and as shown, the credential input mechanism 112 can be embodied as a keypad comprising a plurality of buttons 228, which may be used to enter a predetermined passcode for electronically effecting an engaged state or otherwise controlling operation of the lock 100. The keypad can be any of a variety of different types of keypads (e.g., a numeric keypad, an alpha keypad, an alphanumeric keypad). The buttons 228 may have one or more characters displayed thereon. In some examples, the buttons 228 may be physical buttons that extend through an exterior faceplate, shown as deadbolt rose 230 (as illustrated). In other examples, the keypad may have a plurality of touch areas that use touch to function as buttons 228. For example, the keypad may use a capacitive touch circuit. In the example shown, there are eleven touch areas or buttons 228; however, one skilled in the art should appreciate that in other examples there could be additional or fewer buttons 228.

In some embodiments, the exterior assembly 212 includes a single-touch actuator 232 that can be used to place the lock 100 in an engaged state. For example, when a user selects the single-touch actuator 232, the actuating mechanism included in the exterior assembly 212 rotatably couples the bezel assembly 140 to the torque blade 162 to enable rotation of the bezel assembly 140 to drive rotation of the torque blade 162 to extend or retract the latch bolt 166. In some examples, the single-touch actuator 232 is a button 228. In some examples, the single-touch actuator 232 is a button 228 comprising a particular marking, such as a logo, an icon, one or more characters, etc. The single-touch actuator 232 may be used in place of, or in addition to, the egress assistance techniques described herein. Furthermore, in some examples, the mechanical actuating mechanism 130 includes the bezel assembly 140, but does not include a mechanical lock cylinder 134. In such examples, the bezel assembly is selectable coupled to the torque blade 162 in a similar manner as described herein, but does not expose a keyway or other exterior mechanical lock cylinder componentry.

In alternative embodiments, one or more other types of user interface devices can be incorporated into the lock 100. For example, in example implementations, the exterior assembly 212 can include a biometric interface (e.g., a fingerprint sensor, retina scanner, or camera including facial recognition) by which biometric input can be used; an audio interface by which voice recognition can be used; or a wireless interface by which wireless signals can be used to actuate the engagement mechanism 120. According to another embodiment, a keypad may not be present. In some examples, a user may use a Bluetooth® or Wi-Fi-®-enabled device that transmits signals that may allow the motor to actuate when the device is paired with the lock 100. In such examples, the device may include an application for controlling the lock 100. In other examples, a user may use an RFID or NFC tag that allows the motor to actuate when the correct RFID/NFC tag is detected. In further embodiments, alternative methods of electronically communicating with the motor are contemplated. When a user inputs a valid passcode or other electronic credential via the credential input mechanism 112 that is recognized by the control circuit 114, the electrical motor 116 is energized to actuate the engagement mechanism 120 to couple or decouple the bezel assembly 140 to/from the latch assembly 160 via the coupling mechanism 150.

The control circuit 114 comprises electronic circuitry for the electronic lock 100. In some examples, the control circuit 114 is a printed control circuit configured to receive the credential input of the credential input mechanism 112. When the control circuit 114 receives the correct input, the control circuit 114 sends a signal to the motor 116. The control circuit 114 may also send a signal to the motor 116 when the door 202 is unlocked from the interior side 206. This may assist a user in egress because when the user is leaving premises controlled by the lock 100, the lock 100 may automatically enter the engaged state in which the user can rotate the bezel assembly 140 to lock the door 202 without needing to provide credentials to the credential input mechanism 112, allowing the user to quickly relock the door 202 during egress. To determine whether the door 202 was unlocked from the interior side 206, the control circuit 114 may monitor the position of the latch bolt 166 as well as the interior turn piece 132 and/or the motor 116 to determine when to send a signal to the motor 116. When the control circuit 114 determines that the latch bolt 166 has been moved from a locked position to an unlocked position by rotation of the interior turn piece 132, the control circuit 114 may engage the motor 116. This may transition the lock 100 into the engaged state and the bezel assembly 140 into the coupled state in which rotation of the bezel assembly 140 may move the latch bolt 166 between the locked and unlocked positions. The control circuit 114 may monitor the position of the latch bolt 166 using a switch, such as the switch 1606 depicted in FIGS. 16A, 16B, 17A, and 17B. The control circuit 114 may directly monitor the interior turn piece 132 to determine that the interior turn piece 132 moved the latch bolt 166. In alternative embodiments, the control circuit 114 may monitor the motor 116 as a proxy for the interior turn piece 132; if the latch bolt 166 is moved to the unlocked position and the motor 116 has not been actuated, the control circuit 114 may infer that the latch bolt 166 was moved by the interior turn piece 132. In further embodiments, the control circuit 114 may monitor additional or alternative components of the lock 100 to determine if the latch bolt 166 was moved by the interior turn piece 132.

The lock 100 may only temporarily stay in the engaged state after the control circuit 114 determines that the door 202 was unlocked from the interior side 206, returning the lock 100 to the unengaged state and the bezel assembly 140 to the decoupled state after a predetermined amount of time. When the lock 100 is put into the engaged state because the control circuit 114 determines that the door 202 was unlocked from the interior side 206, the control circuit 114 may start a timer during which the lock 100 remains in the engaged state. When the timer expires, the control circuit 114 may send another signal to the motor 116 to actuate the engagement mechanism 120 to return the bezel assembly 140 to the decoupled state, decoupling the bezel assembly 140 from the latch assembly 160 via the coupling mechanism 150 and returning the lock 100 to the unengaged state. As described further herein, the length of the timer may be customized by a user through an application on a user's computing device.

In some embodiments, the control circuit 114 may transition the lock 100 back into the unengaged state before the timer expires. For example, if the control circuit 114 determines that the latch bolt 166 was moved to the locked position while the lock 100 is temporarily in the engaged state, the control circuit 114 may send a signal to the motor 116 that results in the lock 100 returning to the unengaged state even though the timer is still active. In an embodiment, the control circuit 114 may determine that the latch bolt 166 was moved into the locked position by monitoring the switch 1606.

The control circuit 114 is configured to execute a plurality of software instructions (i.e., firmware) that, when executed by the control circuit 114, cause the electronic lock 100 to implement methods and otherwise operate and have functionality as described herein. The control circuit 114 may comprise a device commonly referred to as a processor, e.g., a central processing unit (CPU), digital signal processor (DSP), or other similar device, and may be embodied as a standalone unit or as a device shared with components of the electronic lock 100. The control circuit 114 may include memory communicatively interfaced to the processor, for storing the software instructions. Alternatively, the electronic lock 100 may further comprise a separate memory device for storing the software instructions that is electrically connected to the control circuit 114 for the bi-directional communication of the instructions, data, and signals therebetween.

In example embodiments, the engagement mechanism 120 and coupling mechanism 150 may include an engagement means, such as is described in U.S. Pat. No. 11,572,708, entitled “Locking Assembly with Spring Mechanism,” the disclosure of which is hereby incorporated by reference in its entirety.

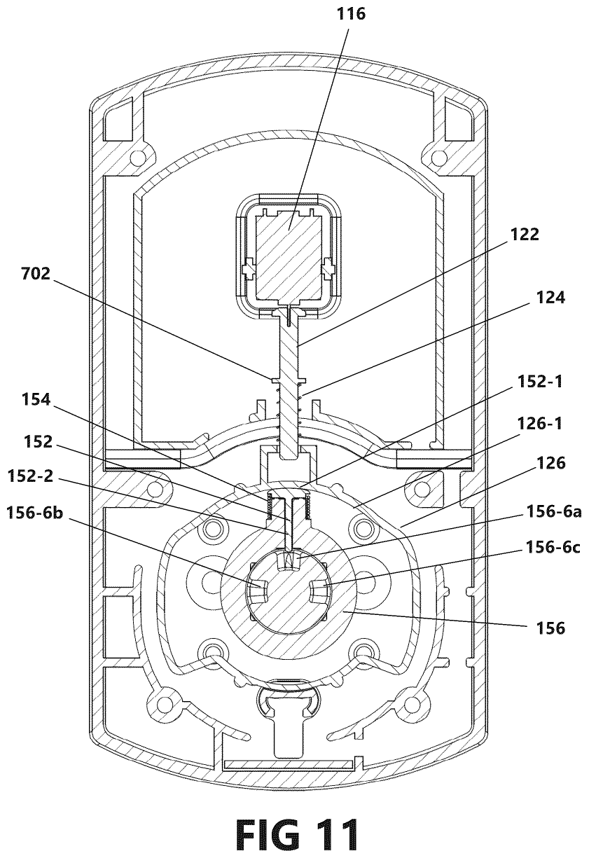

The engagement mechanism 120 includes an actuating spindle 122, a transmission spring 124, and a movable flange 126. As shown in FIGS. 7A, 7B, and 10-15, the motor 116 is operatively coupled to the actuating spindle 122 and is configured to rotate the actuating spindle 122 around a first axis. The actuating spindle 122 is a rod-shaped mechanism oriented around the first axis, for example, vertically within the lock 100. The actuating spindle 122 includes a recess 724 that is connected to the motor 116. The actuating spindle 122 includes a spring driving pin 702 that engages the transmission spring 124 such that, upon rotation of the actuating spindle 122, the transmission spring 124 moves upward or downward relative to the spring driving pin 702 along the first axis between a neutral position (as in FIG. 10) and a biasing position (as in FIG. 11). For example, the motor 116 can rotate the actuating spindle 122 in both a clockwise and a counterclockwise direction, wherein rotation in one direction causes the transmission spring 124 to move upward to the neutral position, and rotation in the other direction causes the transmission spring 124 to move downward along the actuating spindle 122, away from the motor 116 and toward the movable flange 126 to the biasing position. The movable flange 126 is operatively engageable by the transmission spring 124 at least when the transmission spring 124 is in the biasing position.

The coupling mechanism 150 includes a pin 152, an actuator spring 154, and a coupling 156. The flange 126 is movable between a first position and a second position. The flange 126 remains in the first position when the transmission spring 124 is in the neutral position (e.g., being biased upward by actuator spring 154 biasing against the pin 152), and the flange is biased toward the second position when the transmission spring 124 is in the biasing position, since the transmission spring 124 will generally be selected to have a compressive force that is greater than the resisting force of the actuator spring 154. Biasing the flange 126 toward the second position causes the coupling mechanism 150 to drivably couple the bezel assembly 140 to the latch assembly 160.

The pin 152, the actuator spring 154, and the coupling 156 are best shown in FIGS. 7A, 7B, 10, 11, 12, 13, 14, and 15. The pin 152 comprises a head 152-1 and a shaft 152-2 extending therefrom along the first axis. The actuator spring 154 extends around the shaft 152-2 of the pin 152. The coupling 156 comprises a cylindrical body 156-1 positioned along a second axis. For example, the first axis may be defined as vertical and the second axis, also referred to herein as the rotational axis, may be defined as horizontal. The actuator spring 154 is sandwiched between a bottom surface of the head 152-1 of the pin 152 and a top surface of the boss 144-4 included on the sleeve 144.

The pin 152 is aligned with the longitudinal bore 144-5 defined in the boss 144-4 of the sleeve 144, and at least a portion of the shaft 152-2 of the pin 152 is axially slidably received in the longitudinal bore 144-5. The pin 152 is movable between an unengaged position and an engaged position. The pin 152 remains in the unengaged position when the transmission spring 124 and the flange 126 are in the neutral position, and the pin 152 is biased toward the engaged position when the transmission spring 124 and the flange 126 are in the biasing position. For example, when the transmission spring 124 and the flange 126 are in the neutral position, an inner circumferential portion 126-1 of the flange 126 rests atop the head 152-1 of the pin 152, and is not compressing the actuator spring 154. Accordingly, the actuator spring 154 is in a relaxed state, which maintains the pin 152 from being pushed downward and extending through the longitudinal bore 144-5 in the boss 144-4 included in the sleeve 144.

As best shown in FIGS. 7A and 7B, the cylindrical body 156-1 of the coupling 156 has a first portion 156-2 having a first diameter and a second portion 156-3 having a second diameter less than the first diameter. The cylindrical body 156-1 of the coupling 156 comprises a longitudinal opening 156-5 that is dimensioned to slidably receive the torque blade 162, such that the coupling 156 and the torque blade 162 are rotatably coupled. The first portion 156-2 of the cylindrical body of the coupling 156 is slidably received within the longitudinal opening 144-3 defined in the coupling portion 144-2 of the sleeve 144. When the lock 100 is in the unengaged state, the coupling 156 rotates independently from the sleeve 144.

The first portion 156-2 of the cylindrical body 156-1 of the coupling 156 defines at least one recess 156-6 (shown in FIGS. 7A, 7B, 10, 11, and 12) that extends radially inwardly from an outer surface of the first portion 156-2 of the cylindrical body 156-1 toward the longitudinal opening. At least one recess 156-6 is positioned to be alignable along the first axis with the longitudinal bore 144-5, the actuator spring 154, and the pin 152. When the transmission spring 124 is in the neutral position (shown in FIG. 10), the flange 126 remains in the neutral position as well, and the pin 152 remains outside of a plurality of recesses 156-6 (shown as three recesses 156-6a-c positioned at 90 degree angles from each other) within the coupling 156. In this position, the coupling 156 and associated pin 152 may be rotated within the perimeter of the flange 126. Each of the plurality of recesses 156-6 forms a nest which is sized to selectively receive a bottom portion of the shaft of the pin 152 in a radial direction in relation to the cylindrical body 156-1 of the coupling 156.

As shown in FIGS. 11, 12, and 15, when the transmission spring 124 biases the flange 126 downwards toward the second position, the flange 126 biases the actuator spring 154 into a compressed state if and when the pin 152 is aligned with one of the recesses 156-6. This results in pushing the pin 152 downward from the unengaged position to an engaged position. In the engaged position, the pin 152 is biased downward such that, when aligned with a recess 156-6 in the coupling, it resides within the sleeve 144 and the coupling 156. For example, the head 152-1 of the pin 152 is received in the longitudinal bore 144-5 formed in the boss 144-4 included in the sleeve 144, and a bottom portion of the shaft 152-2 of the pin 152 extends through the longitudinal bore 144-5 and is received in the at least one recess 156-6 defined in the cylindrical body 156-1 of the coupling 156. Thus, when the pin 152 is in the engaged position, the sleeve 144, which is rotatably coupled with the bezel 142, is rotatably coupled with the coupling 156. The coupling 156 is rotatably coupled with the torque blade 162, which is drivably received in the spindle passage 204 of the latch spindle 164. Accordingly, when the pin 152 is in the engaged position, the lock 100 is placed in an engaged state where a manual rotation of the bezel assembly 140 drives rotation of the torque blade 162 to extend or retract the latch bolt 166 into an unlocked or locked position. According to an aspect, when the lock 100 is in an engaged state, the retraction and extension of the latch bolt 166 is not driven by the motor 116, but can be driven by the manual rotation of the bezel assembly 140.

As best shown in FIGS. 2B, 5, 7A, and 7B, the external assembly 212 includes the deadbolt rose 230. The deadbolt rose 230 is shown to have a decorative rectangular shape; however, round, square, or other shapes for the deadbolt rose 230 are possible and are within the scope of the present disclosure. As best shown in FIGS. 7A and 7B, the deadbolt rose 230 may define a plurality of holes 708 to receive the buttons 228 of the credential input mechanism 112 embodied as a keypad. The keypad may be made from a variety of materials that are waterproof, such as plastics, rubber, or other similar materials. Further, the connection between the holes 708 of the deadbolt rose 230 and the buttons 228 may comprise a seal to prevent water from penetrating the internal components of the lock 100. As described above, in alternative embodiments, the credential input mechanism 112 may be a biometric interface (e.g., a fingerprint sensor, retina scanner, or camera including facial recognition) by which biometric input can be used, an audio interface by which voice recognition can be used, or a wireless interface (e.g., RFID/NFC tag reader or a Bluetooth® or Wi-Fi® interface at which signals may be received from a paired user device executing an application) by which wireless signals can be used to actuate the engagement mechanism 120. The buttons 228 may extend from the control circuit 114 that transmits electrical signals based on user actuation of the credential input mechanism 112 to a controller in the exterior assembly 212 using a wiring harness (not shown). In this example, a plurality of fasteners 710 secure a back plate 712 and the control circuit 114 to the deadbolt rose 230. As shown, holes in the back plate 712 are aligned with holes in a plate guide 738 as well as a control circuit housing 714, and the control circuit 114, and the fasteners 710 extend therethrough into receptacles in the deadbolt rose 230. The control circuit housing 714 may rest flush against the back plate 712, which may rest flush against the door 202 with supports 716 extending into holes 718 defined in the adaptor 402 and further into holes 234 defined in the latch assembly 160 (shown in FIG. 2C). The adaptor 402 is designed to fit in the bore 214 formed in the door 202. The back plate 712 defines an opening 720 that is aligned with an opening 722 in the adaptor 402, so that second portion 156-3 of the cylindrical body 156-1 of the coupling 156 housing the second end of the torque blade 162 can extend therethrough.

As shown, a collar 706 extends from the deadbolt rose 230. In the example shown, the collar 706 is formed integral with the deadbolt rose 230, but can be a separate component. The collar 706 defines an opening 704 through which the body portion 142-1 of the bezel 142 extends. The outer grip portion 142-3 of the bezel 142 has a diameter that is greater than a diameter of the body portion 142-1 and is located external to the deadbolt rose 230. A locking tab 732 is configured to engage a first slot 726 formed in a sidewall of the collar 706, and a second slot 728 formed in the body portion 142-1 of the bezel 142, so as to connect the bezel assembly 140 to the deadbolt rose 230.

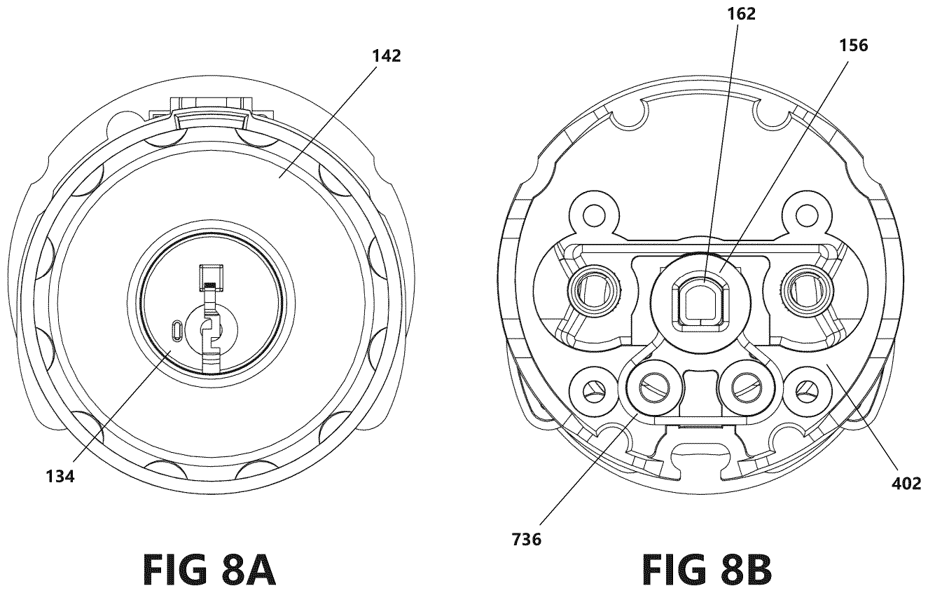

A first clip 734 is shown. The first clip 734 aids in retaining the lock cylinder 134 within the bezel assembly 140. Optionally, the cylinder plug 134-2 can be replaceable by removal of the first clip 734, replacement of the cylinder plug 134-2, and re-insertion of the first clip 734 through slot 730. The lock cylinder 134 and the bezel assembly 140 are rotatably coupled as described above. A second clip 736 is also shown. As best shown in FIG. 8B, the second clip 736 retains the coupling 156 and prevents rotation of the coupling when not engaged by the pin 152.

As best shown in FIGS. 2A, 2C, 4, and 16A-17B, the interior assembly 210 includes an interior faceplate 1602 that defines a recessed area for housing internal components of the interior assembly 210. The interior faceplate 1602 is shown to have a decorative rectangular shape; however, round, square, or other shapes for the interior faceplate 1602 are possible and are within the scope of the present disclosure.

With reference to FIGS. 16A and 16B, the lock 100 is shown in an unlocked state, wherein the latch bolt 166 is retracted and in the unlocked position. The turn piece 132 is rotatably coupled to the torque blade 162 such that when the latch bolt 166 is in the unlocked position, the turn piece 132 is rotated to an unlocked position. As shown, in the unlocked state, the turn piece 132 is in the unlocked position where the turn piece 132 is rotated such that it extends in a vertical direction. The turn piece 132 includes a teardrop washer 1608 that engages a switch 1606 communicatively coupled to the control circuit 114 via an electrical connection. Upon rotation of the turn piece 132 in the unlocked position, the teardrop washer 1608 biases the switch 1606 upward to a disengaged position. According to an aspect, when the lock 100 is in an unlocked state and the turn piece 132 and teardrop washer 1608 are rotated in the unlocked position, the switch 1606 is biased in the disengaged position, which signals to the control circuit 114 that the latch bolt 166 is not thrown and is in the unlocked position. As described above, the exterior assembly 212 includes a single-touch actuator 232 that can be used to place the lock 100 in an engaged state. According to an aspect, the single-touch actuator 232 is electronically actuable when the latch bolt 166 is not thrown and in the unlocked position based on the position of the switch 1606. For example, when the switch 1606 is in the disengaged position as shown in FIG. 16B, the control circuit 114 is informed that the latch bolt 166 is not thrown and in the unlocked position. Accordingly, when the single-touch actuator 232 is selected by a user, the control circuit 114 sends a signal to the motor 116 and energizes the electrical motor 116 to actuate the engagement mechanism 120 to rotatably couple the bezel assembly 140 to the torque blade 162 to enable rotation of the bezel assembly 140 to drive rotation of the torque blade 162 to extend the latch bolt 166 to the locked position.

With reference to FIGS. 17A and 17B, the lock 100 is shown in a locked state, where the turn piece 132 and teardrop washer 1608 are rotated in a locked position. In the locked position, the turn piece 132 extends in a horizontal direction and the teardrop washer 1608 is rotated such that the teardrop point also extends in the horizontal direction. In the locked position, the teardrop washer 1608 is dimensioned to allow the switch 1606 to bias downward to an engaged position, which signals to the control circuit 114 that the latch bolt 166 is thrown and is in the locked position. According to an aspect, the single-touch actuator 232 (seen in FIG. 5) is not electronically actuable when the latch bolt 166 is thrown and in the locked position. Accordingly, based on the engaged position of the switch 1606 when the latch bolt 166 is in the locked position, if the touch actuator 232 is selected by a user, the motor 116 is not energized and does not actuate the engagement mechanism 120 to rotatably couple the bezel assembly 140 to the torque blade 162. Thus, to retract the latch bolt 166 to an unlocked position from the exterior side of the door 202, the user may either use a valid mechanical key 502 in the lock cylinder 134 or may input a valid credential using the credential input mechanism 112 to couple the bezel assembly 140 to the latch assembly 160 and then rotate the bezel 142 to operate the latch bolt 166.

Referring to FIGS. 1-17 generally, it is noted that aspects of the present disclosure may be implemented using an electronic lock, such as an electronically-controlled and manually-actuated lock 100 such as described herein. However, other embodiments of such a lock may be used as well. For example, the methods of operation described herein may be implemented using other manual drive mechanisms that may be electronically controlled, such as seen in U.S. patent application Ser. No. 17/973,599, entitled “Drive Mechanism for Electronic Deadbolt”, the disclosure of which is hereby incorporated by reference in its entirety.

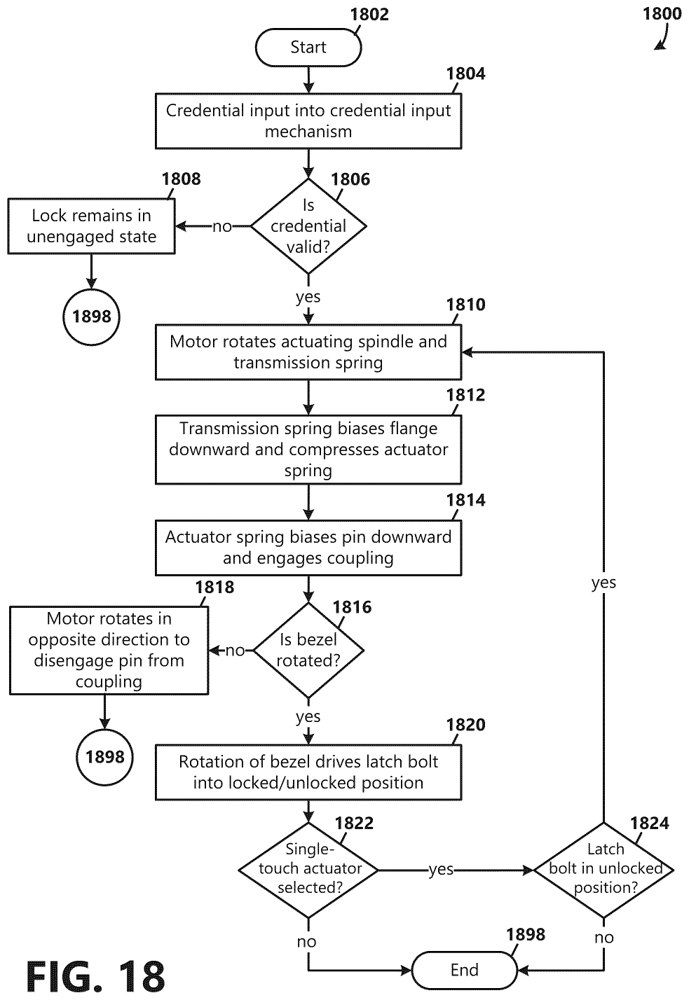

FIG. 18 illustrates an example flowchart of a method 1800 for using the electronically-controlled, manually-actuated deadbolt lock 100 to lock and unlock the door 202. The method 1800 starts at OPERATION 1802 and proceeds to OPERATION 1804 where one or a combination of electronic credentials are received via the credential input mechanism 112. For example, the electronic credential may be a passcode or security token entered via a keypad by a user, a user biometric input received via a biometric sensor, a wireless signal received via a wireless interface, or other electronic credential that may be verified by the control circuit 114 for authentication of a user.

At DECISION OPERATION 1806, a determination may be made as to whether the received credential is valid. For example, the control circuit 114 is coupled in electrical communication with the credential input mechanism 112, and is configured with control logic to discriminate between a valid input credential and an invalid input credential input/provided by a user, a user computing device, an RFID chip, an electronic key fob, etc., via the credential input mechanism 112. When a determination is made that an invalid input credential is received, the motor 116 does not actuate and the electronic lock 100 remains in an unengaged state at OPERATION 1808, where the bezel assembly 140 is drivably decoupled from the torque blade 162, and the manually-operable bezel 142 is incapable of rotating the torque blade 162 to operate the latch bolt 166. When a determination is made that a valid input credential is received, the method 1800 proceeds to OPERATION 1810.

At OPERATION 1810, the control circuit 114 provides a signal to the motor 116, which actuates the motor 116 to rotate the actuating spindle 122. As described above, rotation of the actuating spindle 122 causes the transmission spring 124 to move downward along the actuating spindle 122 away from the motor 116 and toward the movable flange 126 to the biasing position. At OPERATION 1812, the transmission spring 124 engages and biases the flange 126 downward, which compresses the actuator spring 154, and at OPERATION 1814, the pin 152 is pushed downward by the actuator spring 154 to the engaged position. In the engaged position, the pin 152 resides within the sleeve 144 and the coupling 156, and the lock 100 is in an engaged state. Accordingly, the bezel 142, which is rotatably coupled with the sleeve 144, is drivably coupled to the latch assembly 160, which allows for manual rotation of the bezel 142 to retract or extend the latch bolt 166.

At DECISION OPERATION 1816, if the bezel 142 is not rotated within a predetermined period of time (e.g., 10 seconds, 15 seconds, or other period of time), at OPERATION 1818, the motor 116 may automatically rotate the actuating spindle 122 in an opposite direction, which causes the transmission spring 124 to move upward to the neutral position, which disengages the pin 152 from the coupling 156 and places the lock 100 in a disengaged state. If the bezel 142 is rotated within the predetermined period of time, at OPERATION 1820, rotation of the bezel 142 rotates the torque blade 162, which drives the latch spindle 164 to extend or retract the latch bolt 166 into an unlocked or locked position. Advantageously, battery life can be extended due to the bolt action being manually driven by a user, rather than electrically driven by the battery. Additionally, the manually-driven bolt action may provide ample force to retract and/or extend the latch bolt 166 through a misaligned strike plate 220, such as may be the case when a warped door condition is experienced. Accordingly, the warped door condition may be overcome, and without requiring battery power to electrically drive the latch bolt 166.

At DECISION OPERATION 1822, a determination may be made as to whether the single-touch actuator 232 is selected by a user. If the single-touch actuator 232 is selected by a user, at DECISION OPERATION 1824, a determination may be made as to whether the latch bolt 166 is in an unlocked position based on a position of the switch 1606. For example, the switch 1606 in the unlocked position provides a signal to the control circuit 114 that the latch bolt 166 is not thrown and is in the unlocked position, which allows the single-touch actuator 232 to be electronically actuatable. When a determination is made that the latch bolt 166 is in an unlocked position, the method 1800 returns to OPERATION 1810, where the motor 116 is actuated to cause the engagement mechanism 120 to drivably couple the bezel assembly 140 to the latch assembly 160 for enabling rotation of the bezel 142 to extend the latch bolt 166 to a locked position. If the single-touch actuator 232 is not selected by a user, the method 1800 ends at OPERATION 1898.

FIG. 19 illustrates an example flowchart of a method 1900 for providing egress assistance with the electronically-controlled, manually-actuated deadbolt lock 100. The method 1900 starts at OPERATION 1902 and proceeds to OPERATION 1904 where the door 202 is unlocked. This may be done, for example, by rotation of the interior turn piece 132 to move the latch bolt 166 from the locked to the unlocked position.

At DECISION OPERATION 1906, a determination may be made as to whether the door 202 was unlocked from the interior side 206. This may be done by the control circuit 114 determining that the latch bolt 166 was moved from the locked position to the unlocked position by rotation of the interior turn piece 132. The position of the latch bolt 166 may be determined by monitoring the switch 1606. As described above, whether the latch bolt 166 was moved into the unlocked position by the interior turn piece 132 may be done by the control circuit 114 directly monitoring the interior turn piece 132.

In a particular implementation, the control circuit 114 may monitor additional or alternative components of the lock 100 in addition to monitoring the switch 1606 to infer whether the latch bolt 166 is moved in response to activity at the interior assembly 210 or exterior assembly 212. For example, the control circuit 114 may monitor the motor 116; if the latch bolt 166 is moved from the locked to the unlocked position and the motor 116 has not been actuated to cause engagement of the exterior turnpiece, the control circuit 114 may infer that latch bolt 166 was moved by rotation of the interior turn piece 132. By contrast, if the motor 116 was actuated to put the exterior turn piece in the coupled state while the latch bolt 166 is moved to an unlocked position, it may be inferred that the movement was in response to manual actuation at the exterior assembly 212. If a determination is made that the door 202 was not unlocked from the interior side 206, the method 1900 ends. If a determination is made that the door 202 was unlocked from the interior side 206, the method 1900 proceeds to OPERATION 1908.

At OPERATION 1908, the motor 116 is engaged to temporarily transition an exterior turn piece, such as the bezel assembly 140, to the coupled state. While in the coupled state, rotation of the exterior turn piece may drive movement of the latch bolt 166 between the locked and unlocked positions. The exterior turn piece may be put into the coupled state by coupling with the torque blade 162 via the engagement mechanism 120 and the coupling mechanism 150, allowing rotation of the exterior turn piece to effect rotation of the torque blade 162 to move the latch bolt 166 between the locked and unlocked positions.

At OPERATION 1910, a timer is activated. The timer may define a maximum amount of time in which the exterior turn piece is temporarily in the coupled state. The timer may be controlled by the control circuit 114. In an example, the timer is set for 5 seconds. In other examples, different predetermined time periods may be selected, for example in a range of 5-10 seconds, or between 3-30 seconds. As described herein, the length of the timer may be customized by a user through an electronic lock application on a mobile device paired with the lock 100.

At DECISION OPERATION 1912, it is determined if the door 202 has been locked. This may be done by the control circuit 114. For example, the control circuit 114 may monitor the position of the latch bolt 166 through the switch 1606. If movement of the latch bolt 166 to the locked position flips the switch 1606, the control circuit 114 may determine that the door 202 has been locked. If a determination is made that the door 202 has not been locked, the method proceeds to DECISION OPERATION 1914. If a determination is made that the door 202 has been locked, the method 1900 proceeds to OPEARATION 1916.

At DECISION OPERATION 1914, it is determined if the timer has expired. If a determination is made that the timer has not expired, the method 1900 returns to DECISION OPERATION 1912. The method may loop between DECISION OPERATION 1912 and DECISION OPERATION 1914 until either the door 202 is locked or the timer expires. If a determination is made that the timer has expired, the method 1900 proceeds to OPERATION 1916.

At OPERATION 1916, the motor 116 is engaged to transition the exterior turn piece back to the decoupled state. While in the decoupled state, rotation of the exterior turn piece may not drive movement of the latch bolt 166 between the locked and unlocked positions. The exterior turn piece may be put into the decoupled state by uncoupling the exterior turn piece from the torque blade 162. After the exterior turn piece 140 is transitioned to the decoupled state, the method 1900 ends at OPERATION 1998.

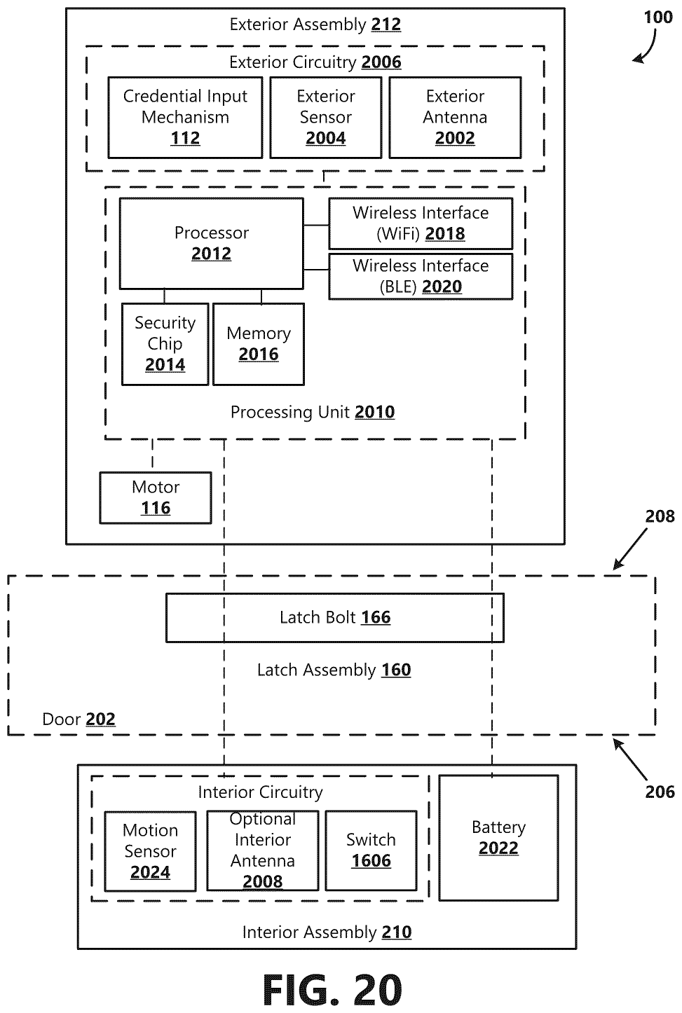

FIG. 20 is a schematic representation of the electronic lock 100 mounted to the door 202. The interior assembly 210, the exterior assembly 212, and the deadbolt latch assembly 160 are shown.

The exterior assembly 212 is shown to include various exterior circuitry 2006 including the credential input mechanism 112 and an optional exterior antenna 2002 usable for communication with a remote device. In addition, the exterior circuitry 2006 can include one or more sensors 2004, such as a camera, proximity sensor, or other mechanism by which conditions exterior to the door 202 can be sensed. In response to such sensed conditions, notifications may be sent by the electronic lock 100 to a server or a user's mobile device including information associated with a sensed event (e.g., time and description of the sensed event, or remote feed of sensor data obtained via the sensor).

The exterior antenna 2002 is capable of being used in conjunction with an interior antenna 2008, such that, for example, a processing unit 2010 can determine where a mobile device is located, wherein only a mobile device that is paired with the electronic lock 100 and determined to be located on the exterior of the door 202 is able to actuate the motor 116 to place the lock 100 in an engaged state. As can be appreciated, this can prevent unauthorized users from being located exterior to the door 202 of the electronic lock 100 and taking advantage of an authorized mobile device that may be located on the interior of the door 202, even though that authorized mobile device is not being used to actuate the motor 116. However, such a feature is not required, but can add additional security. In alternative arrangements, the motor 116 may be actuatable from either the credential input mechanism 112 or from an application installed on a user's mobile device. In such arrangements, the exterior antenna 2002 and/or interior antenna 2008 may be excluded.

The exterior assembly 212 may further include the processing unit 2010 and the motor 116. In alternative embodiments, the processing unit 2010 may be included in the interior assembly 210. As shown, the processing unit 2010 includes at least one processor 2012 communicatively connected to a security chip 2014, a memory 2016, various wireless communication interfaces (e.g., including a Wi-Fi® interface 2018 and/or a Bluetooth® interface 2020, and a battery 2022). The processing unit 2010 is capable of controlling the engagement state of the electronic lock 100 (e.g., by actuating the motor 116 to actuate and drivably couple the bezel assembly 140 to the latch assembly 160.

In some examples, the processor 2012 can process signals received from a variety of devices to determine whether the motor 116 should be actuated. Such processing can be based on a set of preprogramed instructions (i.e., firmware) stored in the memory 2016. In certain embodiments, the processing unit 2010 can include a plurality of processors 2012, including one or more general purpose or specific purpose instruction processors. In some examples, the processing unit 2010 is configured to capture a credential input event from a user and store the credential input event in the memory 2016. In other examples, the processor 2012 receives a signal from the exterior antenna 2002, the interior antenna 2008, or a motion sensor 2024 (e.g., a vibration sensor, gyroscope, accelerometer, motion/position sensor, or combination thereof) and can validate received signals in order to actuate the motor 116 to control the engagement state of the electronic lock 100. In still other examples, the processor 2012 receives signals from the Bluetooth® interface 2020 to determine whether to actuate the motor 116.

In further examples, the processing unit 2010 is configured to monitor whether the door 202 has been unlocked from the interior side 206 to determine whether the motor 116 should be actuated. The processing unit may this by monitoring a position of the latch bolt 166 and the interior turn piece 132. The processing unit 2010 may determine that the latch bolt 166 was moved from a locked position to an unlocked position by using the switch 1606. The processing unit 2010 may directly monitor the position of the interior turn piece 132 to determine that the interior turn piece 132 was rotated to move the latch bolt 166. Alternatively, the processing unit 2010 may monitor the status of the motor 116 to determine that the latch bolt 166 was moved by the interior turn piece 132. For example, if the processing unit 2010 determines that motor 116 had not been actuated but the latch bolt 166 had been moved to the unlocked position, the processing unit 2010 may infer that this was caused by rotation of the interior turn piece 132. The motor 116 may need to be actuated for rotation of an exterior turn piece (such as the bezel assembly 140 depicted in FIGS. 1, 2B, 3, 4, 5, 6A, and 6B) to move the latch bolt 166, as described above, so any movement of the latch bolt 166 without actuation of the motor 116 may be inferred to be caused by rotation of the interior turn piece 132. Further, the processing unit 2010 may use signals from the exterior sensor 2004 to determine that latch bolt 166 was moved by the interior turn piece 132. For example, if the exterior sensor 2004 is a proximity sensor and does not detect the presence of a user exterior to the door 202, the processing unit 2010 may infer that movement of the latch bolt 166 was caused by rotation of the interior turn piece 132. In other embodiments, the processing unit 2010 may use signals from the exterior antenna 2002 and/or the interior antenna 2008 to determine whether movement of the latch bolt into the unlocked position was caused by the interior turn piece 132. If the processing unit 2010 determines that a mobile device paired with the electronic lock 100 is located on the interior of the door 202 when the latch bolt 166 is moved into the unlocked position, the processing unit may infer that the latch bolt 166 was moved using the interior turn piece 132.

As described above, when the motor 116 is actuated because the processing unit 2010 determines that the lock 100 has been unlocked from the interior side 206, the lock 100 may only temporarily be placed in the engaged state. For example, the processing unit 2010 may activate a timer when the lock 100 is put into the engaged state in this manner, and upon expiration of the timer, the processing unit 2010 actuates the motor 116 to return the lock 100 to the unengaged state. The processing unit 2010 may return the lock 100 to the unengaged state before the timer expires. For example, if the latch bolt 166 is moved into the locked position, the processing unit 2010 may actuate the motor 116 to return the lock 100 to the unengaged state even if the timer is still active.

In some embodiments, the processing unit 2010 includes a security chip 2014 that is communicatively interconnected with one or more instances of the processor 2012. The security chip 2014 can, for example, generate and store cryptographic information usable to generate a certificate usable to validate the electronic lock 100 with a remote system, such as a server or a mobile device. In certain embodiments, the security chip 2014 includes a one-time write function in which a portion of memory of the security chip 2014 can be written only once, and then locked. Such memory can be used, for example, to store cryptographic information derived from characteristics of the electronic lock 100. Accordingly, once written, such cryptographic information can be used in a certificate generation process which ensures that, if any of the characteristics reflected in the cryptographic information are changed, the certificate that is generated by the security chip 2014 would become invalid, and thereby render the electronic lock 100 unable to perform various functions, such as communicate with a server or mobile device, or operate at all, in some cases.

The memory 2016 can include any of a variety of memory devices, such as using various types of computer-readable or computer storage media. A computer storage medium or computer-readable medium may be any medium that can contain or store the program for use by or in connection with the instruction execution system, apparatus, or device. By way of example, computer storage media may include dynamic random access memory (DRAM) or variants thereof, solid state memory, read-only memory (ROM), electrically erasable programmable ROM, and other types of devices and/or articles of manufacture that store data. Computer storage media generally includes at least one or more tangible media or devices. Computer storage media can, in some examples, include embodiments including entirely non-transitory components.

As noted above, the processing unit 2010 can include one or more wireless interfaces, such as the Wi-Fi® interface 2018 and/or the Bluetooth® interface 2020. Other RF circuits can be included as well. In the example shown, the Wi-Fi® interface 2018 and/or the Bluetooth® interface 2020 are capable of communication using at least one wireless communication protocol. In some examples, the processing unit 2010 can communicate with a remote device via the Wi-Fi® interface 2018, or a local device via the Bluetooth® interface 2020. In some examples, the processing unit 2010 can communicate with a mobile device and a server via the Wi-Fi® interface 2018, and can communicate with a mobile device when the mobile device is in proximity to the electronic lock 100 via the Bluetooth® interface 2020. In some embodiments, the processing unit 2010 is configured to communicate with a mobile device via the Bluetooth® interface 2020, and communications between the mobile device and the electronic lock 100 when the mobile device is out of range of Bluetooth® can be relayed via a server using the Wi-Fi® interface 2018.

In example aspects, various wireless protocols can be used. For example, the electronic lock 100 can utilize one or more wireless protocols including, but not limited to, the IEEE 802.11 standard (Wi-Fi®), the IEEE 802.15.4 standard (Zigbee® and Z-Wave®), the IEEE 802.15.1 standard (Bluetooth®), a cellular network, a wireless local area network, near-field communication protocol, and/or other network protocols. In some examples, the electronic lock 100 can wirelessly communicate with networked and/or distributed computing systems, such as may be present in a cloud-computing environment.

According to an embodiment, the processor 2012 may receive a signal at the Bluetooth® interface 2020 via a wireless communication protocol (e.g., BLE) from a mobile device for communication of an intent to actuate the motor 116 to control the engagement state of the electronic lock 100. In some examples, the processor 2012 may initiate communication with a server via the Wi-Fi® interface 2018 (or another wireless interface) for purposes of validating an attempted actuation of the motor 116 to control the engagement state of the electronic lock 100, or receiving an actuation command to actuate the motor 116 to control the engagement state of the electronic lock 100. Additionally, various other settings can be viewed and/or modified via the Wi-Fi® interface 2018 from a server; as such, a user of a mobile device may access an account associated with the electronic lock 100 to view and modify settings of that lock, which are then propagated from the server to the electronic lock 100. In alternative embodiments, other types of wireless interfaces can be used; generally, the wireless interface used for communication with a mobile device can operate using a different wireless protocol than a wireless interface used for communication with a server.

The exterior assembly 212 also includes the motor 116 that is capable of actuating the engagement mechanism 120. In use, the motor 116 receives an actuation command from the processing unit 2010, which causes the motor 116 to actuate the engagement mechanism 120 to place the lock 100 in an engaged state. In some examples, the motor 116 actuates the engagement mechanism to an opposing state. In some examples, the motor 116 receives a specified engage command responsive to a selection of the single-touch actuator 232, where the motor 116 only actuates the engagement mechanism 120 if the latch bolt 166 is in the unlocked position. For example, if the door 202 is locked and the processing unit 2010 receives an indication of a selection of the single-touch actuator 232, then no action is taken. If the latch bolt 166 is in the unlocked position and the processing unit 2010 receives an indication of a selection of the single-touch actuator 232, then the motor 116 actuates the engagement mechanism 120 to place the lock 100 in an engaged state such that manual rotation of the bezel 142 extends the latch bolt 166 in the locked position. In another example, as described above, the motor 116 may receive the actuation command from the processing unit in response to the processing unit 2010 determining that the latch bolt 166 has been moved from the locked position to the unlocked position by rotation of an internal turn piece.

The interior assembly 210 may include one or more batteries 2022 to power the electronic lock 100. In one example, the batteries 2022 may be a standard single-use (disposable) battery. Alternatively, the batteries 2022 may be rechargeable. In still further embodiments, the batteries 2022 are optional, replaced by an alternative power source (e.g., an AC power connection).

In the example shown, the interior assembly 210 includes the switch 1606, described previously. The switch 1606 interfaces with latch assembly 160 to determine a locked position or an unlocked position of the latch bolt 166. In alternative embodiments, the switch may be implemented differently; for example, a hall effect sensor and magnet arrangement may be used to detect position of the latch bolt.

Although the processing unit 2010 is illustrated as being included in the exterior assembly 212 in the example shown, in alternative embodiments, the processing unit 2010 may be located within the interior assembly 210. In such an arrangement the processing unit 2010 may receive signals from the exterior circuitry 2006, and may actuate the motor 116 via an electrical connection between the interior assembly 210 and the exterior assembly 212 through the bore 214 in the door 202.

In still further example embodiments, the electronic lock 100 can include an integrated motion sensor 2024. Using such a motion sensor 2024 (e.g., an accelerometer, gyroscope, or other position or motion sensor) and wireless capabilities of a mobile device or an electronic device (i.e., fob) with these capabilities embedded inside can assist in determining additional types of events (e.g., a door opening or door closing event, a lock actuation or lock position event, or a knock event based on vibration of the door). In some cases, motion events can cause the electronic lock 100 to perform certain processing, e.g., to communicatively connect to or transmit data to a mobile device in proximity to the electronic lock 100. In alternative embodiments, other lock engagement sequences may not require use of a motion sensor 2024. For example, if a mobile device is in valid range of the electronic lock 100 when using a particular wireless protocol (e.g., Bluetooth Low Energy), then a connection may be established with the electronic lock 100. Other arrangements are possible as well, using other connection sequences and/or communication protocols.

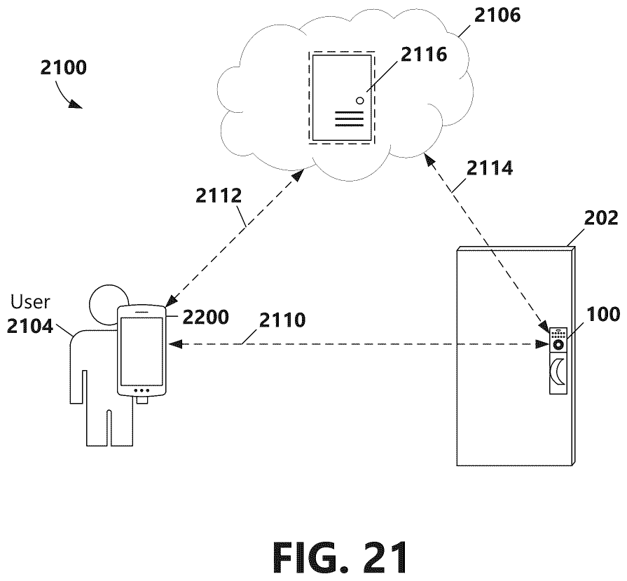

FIG. 21 illustrates an environment 2100 in which a user 2104 may control the lock 100 or may customize settings for the lock 100 through a mobile device or other computing device 2200 with wireless communication capabilities. The mobile device 2200 is capable of communicating 2112 with a server 2116 and communicating 2110 with the lock 100. The server 2116 may be, for example, a physical server or a virtual server hosted in a cloud storage environment 2106. In some embodiments, the lock 100 is also capable of communicating 2114 with the server 2116. Such communication can optionally occur via one or more wireless communication protocols, e.g., Wi-Fi® (IEEE 802.11), short-range wireless communication to a Wi-Fi® bridge, or other connection mechanism. The server 2116 may authenticate the lock 100 before establishing a secure connection. Alternatively, the lock 100 can authenticate the server 2116 to establish a secure connection. In some instances, the server 2116 and the lock 100 operate to mutually authenticate each other in order to provide a higher level of security when establishing a connection.

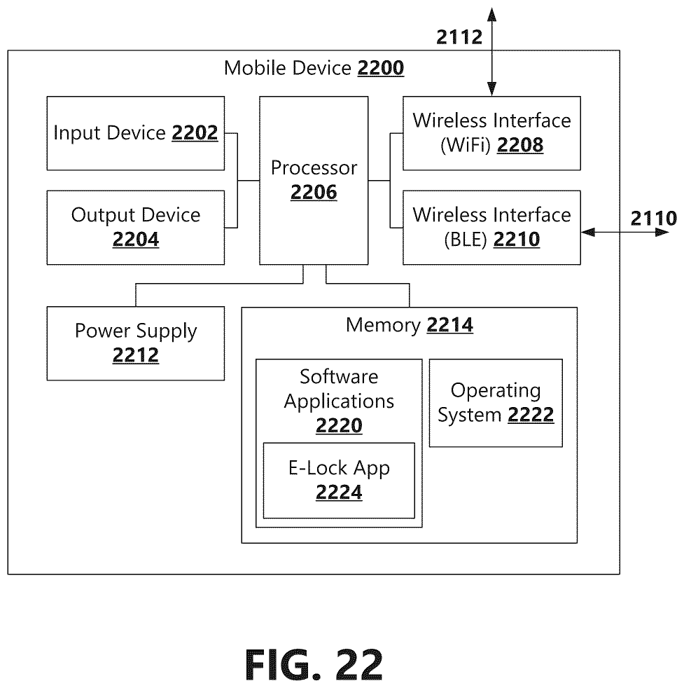

FIG. 22 illustrates a schematic diagram of a mobile device 2200 usable in embodiments of the disclosure to control an electronic lock and customize settings for the lock. In some embodiments, the mobile device 2200 operates to form a Bluetooth® or BLE connection 2110 with a network enabled security device such as the electronic lock 100. In alternative embodiments, the mobile device 2200 may form a Wi-Fi® or mobile data connection 2112 with the lock 100. The mobile device 2200 may also communicate with a cloud server via a Wi-Fi® or mobile data connection 2112. The mobile device 2200 may operate to communicate information between the lock and the server. The mobile device 2200 shown in FIG. 22 includes an input device 2202 an output device 2204, a processor 2206, network communication devices such as a wireless Wi-Fi® interface 2208 and a wireless BLE interface 2210, a power supply 2212, and a memory 2214.

The input device 2202 operates to receive input from external sources. Such sources may include inputs received from a user. The inputs may be received through a touchscreen, a stylus, a keyboard, etc.

The output device 2204 operates to provide output of information from the mobile device 2200. For example, a display could output visual information while a speaker could output audio information.

The processor 2206 reads data and instructions. The data and instructions can be stored locally, received from an external source, or accessed from removable media.

The wireless interface 2208 may be similar to the Wi-Fi® interface 2018 described above. A Wi-Fi® connection 2112 may be established with a cloud server (such as the cloud server 2116 depicted in FIG. 21). In alternative embodiments, a Wi-Fi® connection 2112 may be established with the lock 100.

The wireless interface 2210 may be similar to the Bluetooth® interface 2020 described above. A BLE connection 2110 may be established with an electronic lock (such as the lock 100).

The power supply 2212 provides power to the processor 2206.

The memory 2214 includes software applications 2220 and an operating system 2222. The memory 2214 contains data and instructions that are usable by the processor 2206 to implement various functions of the mobile device 2200.

The software applications 2220 may include applications usable to perform various functions on the mobile device 2200. One such application is an electronic lock application 2224. The electronic lock application 2224 may be configured to provide a user interface, setup/activate the lock 100, actuate the lock 100, and customize settings for the lock 100. The electronic lock application 2224 may communicate with the lock 100 directly through the Bluetooth® interface 2020. Alternatively, the electronic lock application 2224 may communicate with the server 2116 through the Wi-Fi® interface 2018, and the server 2116 may communicate with the lock 100.

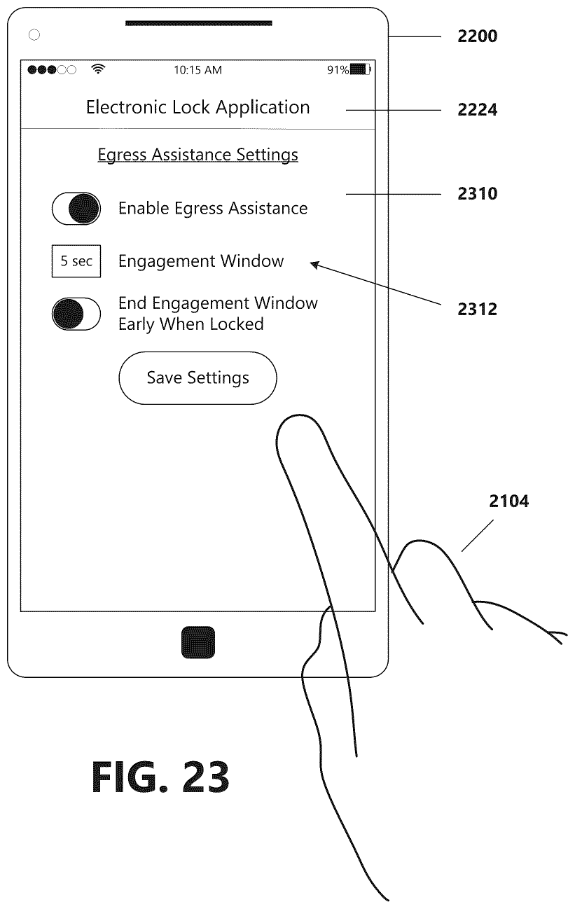

FIG. 23 illustrates a pictorial representation of customizing settings for the lock 100 through the electronic lock application 2224. An example representation of a user interface 2310 of the electronic lock application 2224 is shown displayed on a screen of an example mobile device 2200. This user interface 2310 may be shown after successful setup or installation of the lock 100 and pairing of the mobile device 2200 with the lock 100. The user interface 2310 may display various settings 2312. In the illustrated embodiments, the settings 2312 allow a user 2104 to modify features of the lock 100 related to egress assistance.

For example, the user 2104 may be able to enable or disable egress assistance. When egress assistance is disabled, the motor 116 may not be actuated when the lock 100 determines that the door 202 was unlocked from the interior side 206. Alternatively, when egress assistance is enabled, the motor 116 may be actuated when the lock 100 determines that the door 202 was unlocked from the interior side 206. The settings 2312 may similarly enable a user 2104 to customize aspects of the egress assistance. The user 2104 may be able to set different values for an engagement window. The engagement window may define how long the exterior turn piece is in the coupled state and the lock 100 is in the engaged state after the lock 100 determines that the door 202 was unlocked from the interior side 206. The value set for the engagement window in the settings 2312 may determine the length of a timer set by the lock 100 during which the exterior turn piece is in the coupled state and the lock 100 is in the engaged state. The settings 2312 may also include an option to end the engagement window early if the door 202 is locked before the expiration of the engagement window. In alternative embodiments, the settings 2312 may include additional or alternative customization options for the lock, some of which may not be related to egress assistance features.

As described above, when settings 2312 for the lock 100 are changed through the electronic lock application 2224, the electronic lock application 2224 may communicate the settings 2312 directly to the lock 100. Alternatively, the electronic lock application 2224 may communicate the settings 2312 with the server 2116, and the server 2116 may communicate the settings 2312 with the lock 100.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. An electronically-controlled, manually-actuated lock, comprising:
a deadbolt latch assembly including a latch bolt movable between a locked position and an unlocked position;
an interior turn piece coupled to the deadbolt latch assembly, wherein rotation of the interior turn piece drives movement of the latch bolt between the locked and unlocked positions;
an exterior turn piece selectively couplable to the deadbolt latch assembly, wherein when the exterior turn piece is in a coupled state, rotation of the exterior turn piece drives movement of the latch bolt between the locked and unlocked positions;
a control circuit; and
a motor coupled with the control circuit,
wherein when the control circuit determines that rotation of the interior turn piece drives movement of the latch bolt from the locked position to the unlocked position, the control circuit engages the motor to transition the exterior turn piece into the coupled state for, at most, a predetermined amount of time.

2. The electronically-controlled, manually-actuated lock of claim 1, wherein the control circuit is configured to operate a timer defining the predetermined amount of time.

3. The electronically-controlled, manually-actuated lock of claim 1, wherein when the control circuit determines that the latch bolt moved from the locked position to the unlocked position during the predetermined amount of time, the control circuit engages the motor to transition the exterior turn piece out of the coupled state.

4. The electronically-controlled, manually-actuated lock of claim 1, wherein after the predetermined amount of time, the control circuit engages the motor to transition the exterior turn piece out of the coupled state.

5. The electronically-controlled, manually-actuated lock of claim 1, wherein the predetermined amount of time is customizable.

6. The electronically-controlled, manually-actuated lock of claim 1, wherein the exterior turn piece transitions into the coupled state by actuation of an engagement mechanism to couple the exterior turn piece to the latch assembly via a coupling mechanism.

7. The electronically-controlled, manually-actuated lock of claim 1, wherein the control circuit determines that rotation of the interior turn piece drives movement of the latch bolt from the locked position to the unlocked position by monitoring a switch and the motor, the switch movable between engaged and disengaged positions by movement of the latch bolt.

8. A method for managing egress at a door, the method comprising:
determining that a latch bolt has been moved from a locked position to an unlocked position by an interior turn piece; and
engaging a motor to transition an exterior turn piece into a coupled state for, at most, a predetermined amount of time, wherein, in the coupled state, rotation of the exterior turn piece drives movement of the latch bolt between the locked and unlocked positions, and in a decoupled state, the exterior turn piece is mechanically disengaged from the latch bolt.

9. The method of claim 8, further comprising:
initiating a timer for the predetermined amount of time;
determining that the timer has expired; and
engaging the motor to transition the exterior turn piece into the decoupled state, wherein when the exterior turn piece is in the decoupled state, rotation of the exterior turn piece does not drive movement of the latch bolt.

10. The method of claim 8, further comprising:
determining that the latch bolt has been moved from the unlocked position to the locked position; and
engaging the motor to transition the exterior turn piece into the decoupled state, wherein when the exterior turn piece is in the decoupled state, rotation of the exterior turn piece does not drive movement of the latch bolt.

11. The method of claim 8, wherein the predetermined amount of time is customizable.

12. The method of claim 8, wherein engaging the motor to transition the exterior turn piece into the coupled state for, at most, the predetermined amount of time includes:
actuating an engagement mechanism with the motor to couple the exterior turn piece to the latch bolt via a coupling mechanism.

13. The method of claim 8, wherein determining that the latch bolt has been moved from the unlocked position to the locked position by the interior turn piece includes:
monitoring a position of the latch bolt;
monitoring the motor; and
determining that a switch has been moved from an engaged position to a disengaged position without engaging the motor.

14. The method of claim 13, wherein monitoring the position of the latch bolt includes:
monitoring the switch, the switch movable between engaged and disengaged positions by movement of the latch bolt between the locked and unlocked positions.

15. A system for managing egress at a door, the system comprising:
an electronic lock, including:
a deadbolt latch assembly including a latch bolt movable between a locked position and an unlocked position;
an interior turn piece coupled to the deadbolt latch assembly, wherein rotation of the interior turn piece drives movement of the latch bolt between the locked and unlocked positions;
an exterior turn piece selectively couplable to the deadbolt latch assembly, wherein in a coupled state, rotation of the exterior turn piece drives movement of the latch bolt between the locked and unlocked positions, and in a decoupled state, the exterior turn piece is mechanically disengaged from the latch bolt;
a control circuit; and
a motor coupled with the control circuit,
wherein when the control circuit determines that rotation of the interior turn piece drives movement of the latch bolt from the locked position to the unlocked position, the control circuit engages the motor to transition the exterior turn piece into the coupled state for, at most, a predetermined period of time.

16. The system of claim 15, further comprising:
a computing device pairable with the electronic lock, the computing device including:
a network communication device configured to communicate with the electronic lock.

17. The system of claim 16, wherein the control circuit determines that rotation of the interior turn piece drives movement of the latch bolt from the locked position to the unlocked position by monitoring a location of the computing device and a position of the latch bolt,
wherein when the control circuit determines that the computing device is on an interior side of the door when the latch bolt moves from the locked position to the unlocked position, the control circuit infers that the interior turn piece drove movement of the latch bolt from the locked position to the unlocked position.

18. The system of claim 16, wherein the computing device further includes:
an electronic lock application configured to modify a setting of the electronic lock.

19. The system of claim 18, wherein the electronic lock application is configured to modify an engagement window for the electronic lock, the engagement window defining the predetermined period of time for which the exterior turn piece is temporarily in the coupled state.

20. The system of claim 15, wherein when the control circuit determines that, during the predetermined period of time, the latch bolt is moved from the locked position to the unlocked position while the exterior turn piece is in the coupled state, the control circuit engages the motor to transition the exterior turn piece out of the coupled state.
